(19) United States
(12) Patent Application Publication
(10) Pub. No.: US 2024/0057051 A1
(43) Pub. Date: Feb. 15, 2024

(54) SUBBAND-SPECIFIC CHANNELS AND SIGNALS CONFIGURATION

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US); Abdelrahman Mohamed Ahmed Mohamed IBRAHIM, San Diego, CA (US); Ahmed Attia ABOTABL, San Diego, CA (US)

(21) Appl. No.: 18/184,628

(22) Filed: Mar. 15, 2023

Related U.S. Application Data
(60) Provisional application No. 63/397,334, filed on Aug. 11, 2022.

(51) Int. Cl. H04W 72/0453; H04L 5/14

(52) U.S. Cl. CPC H04W 72/0453; H04L 5/1469

(57) ABSTRACT

Methods and apparatus related to a network entity and a user equipment are described. The network entity is configured to receive an indication that a user equipment is aware of subband full-duplex operation and transmit, in response to receiving the indication, at least one of a downlink subband full-duplex-specific channels and signals configuration or an uplink subband full-duplex-specific channels and signals configuration. The user equipment is configured transmit an indication that the user equipment is aware of subband full-duplex operation, and, in response to transmitting the indication, receive scheduling information from a network entity indicating that the user equipment is scheduled to transmit uplink or receive downlink in at least one of: a subband full-duplex (SBFD) slot, or a flexible symbol.

### CROSS-REFERENCE TO RELATED APPLICATIONS

This application for patent claims priority to and the benefit of provisional patent application No. 63/397,334 entitled “Subband-Specific Channels and Signals Configuration” filed in the United States Patent and Trademark Office on Aug. 11, 2022, the entire content of which is incorporated herein by reference as if fully set forth below in its entirety and for all applicable purposes.

### TECHNICAL FIELD

The technology discussed below relates generally to wireless communication devices in a wireless communication network and, more particularly, to network-determined subband-specific channels and signals configurations.

### INTRODUCTION

As communication networks evolve, ways to improve latency and optimize the amount of data conveyed over frequency resources are investigated and may be incorporated into standards utilized by wireless communication networks. For example, using time division duplexing (TDD), each slot is scheduled for uplink or downlink, but not both. Self-contained slots have been introduced so that a single slot may be scheduled with non-overlapping time resources for uplink and downlink. Use of self-contained slots in a time division duplexing (TDD) system may therefore improve latency. Another type of duplexing that may improve latency and other communications characteristics beyond self-contained slots in TDD systems may be referred to as subband full-duplex (SBFD). According to SBFD, a given slot may be configured for simultaneous uplink and downlink communications.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a network access node is disclosed. The network node includes a memory and a processor coupled to the memory. In the example, the processor is configured to, based at least in part on information stored in the memory: receive an indication that a user equipment is aware of subband full-duplex operation; and transmit, in response to receiving the indication, at least one of a downlink subband-specific channels and signals configuration or an uplink subband-specific channels and signals configuration utilizing radio resource control (RRC) signaling.

In another example, a method, operational at a network access node, is disclosed. The method includes receiving an indication that a user equipment is aware of subband full-duplex operation; and transmitting, in response to receiving the indication, at least one of a downlink subband-specific channels and signals configuration or an uplink subband-specific channels and signals configuration utilizing radio resource control (RRC) signaling.

In another example, an apparatus is disclosed. In the example, the apparatus includes: means for receiving an indication that a user equipment is aware of subband full-duplex operation; and means for transmitting, in response to receiving the indication, at least one of a downlink subband-specific channels and signals configuration or an uplink subband-specific channels and signals configuration utilizing radio resource control (RRC) signaling.

In one example a computer-readable medium storing computer-executable code is disclosed. In the example, the computer-executable code stored on the computer-readable medium includes instructions for: receiving an indication that a user equipment is aware of subband full-duplex operation; and transmitting, in response to receiving the indication, at least one of a downlink subband-specific channels and signals configuration or an uplink subband-specific channels and signals configuration utilizing radio resource control (RRC) signaling.

In still another example, a user equipment (UE), comprising a memory and a processor coupled to the memory is disclosed. In this example the processor is configured to, based at least at least in part on information stored in the memory: receive scheduling information from a network access node indicating that the UE is scheduled to transmit uplink or receive downlink in at least one of: a subband full-duplex (SBFD) slot, or a flexible symbol or slot.

In another example, a method, operational at a user equipment, is disclosed. In the example, the method includes: receiving scheduling information from a subband full-duplex-capable network access node indicating that the UE is scheduled to transmit uplink or receive downlink in at least one of: a subband full-duplex (SBFD) slot, or a flexible symbol or slot.

In still another example, an apparatus is disclosed. In this example, the apparatus includes means for receiving scheduling information from a subband full-duplex-capable network access node indicating that the UE is scheduled to transmit uplink or receive downlink in at least one of: a subband full-duplex (SBFD) slot, or a flexible symbol or slot.

In still another example, a computer-readable medium storing computer-executable code is disclosed. In the example the computer-executable code stored on the computer-readable medium includes instructions for: receiving scheduling information from a subband full-duplex-capable network access node indicating that the UE is scheduled to transmit uplink or receive downlink in at least one of: a subband full-duplex (SBFD) slot, or a flexible symbol or slot.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a textual representation of portions of downlink (DL) and uplink (UL) bandwidth part (BWP) configurations according to some aspects of the disclosure.

FIGS. 5A and 5B are schematic representations of first and second examples of a plurality of slots utilizing various duplex modes according to some aspects of the disclosure.

FIG. 6 is a schematic representation of a plurality of full-duplex gNBs, half-duplex UEs, and full-duplex UEs, and a corresponding graphical depiction of time-frequency resources for uplink and downlink transmissions according to some aspects of the disclosure.

FIG. 7 is an illustration of a plurality of slots including slots scheduled for subband full-duplex communications according to some aspects of the disclosure.

FIG. 8 is an illustration of a first slot and a second slot, along with parametric data that may be used to configure the first slot and the second slot according to some aspects of the disclosure.

FIG. 9 is an illustration of a first slot and a second slot, along with parametric data that may be used to configure the first slot and the second slot according to some aspects of the disclosure.

FIG. 10 is a block diagram illustrating an example of a hardware implementation of a network access node employing a processing system according to some aspects of the disclosure.

FIG. 11 is a flow chart illustrating an exemplary process at a network access node according to some aspects of the disclosure.

FIG. 12 is a block diagram illustrating an example of a hardware implementation of a user equipment employing a processing system according to some aspects of the disclosure.

FIG. 13 is a flow chart illustrating an exemplary process at a network access node according to some aspects of the disclosure.

FIG. 14 is a schematic illustration of an example disaggregated base station architecture according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are methods and apparatus directed toward bandwidth part (BWP), cell-common, and user equipment (UE) dedicated channels and signals configurations. According to some aspects, the channels and signals configurations may be subband full duplex specific channels and signals configurations, referred to herein as subband-specific channels and signals configurations.

Downlink (DL) and uplink (UL) BWP configurations may be divided into BWP common and BWP dedicated parameters. The BWP common parameters may be cell specific, implying that a network may act to ensure that the BWP common parameters (i.e., parameters that correspond to the BWP common parameters) may be aligned across UEs that are served by network access nodes (e.g., scheduling entities, gNBs) scheduling communications within relevant cells. The BWP dedicated parameters may be UE specific.

The BWP common parameters for a DL BWP with a nonzero index may include basic cell-specific BWP parameters (e.g., frequency domain location, bandwidth, subcarrier spacing (SCS), and a cyclic prefix associated with a given cell-specific BWP) and additional cell-specific BWP parameters for a physical downlink control channel (PDCCH) and a physical downlink shared channel (PDSCH) associated with the given DL BWP.

The BWP dedicated parameters for a DL BWP with a nonzero index may include UE specific parameters for the PDCCH and the PDSCH, UE specific parameters for semi-persistent scheduling, and UE specific parameters for radio link monitoring configurations associated with a given DL BWP.

The BWP common parameters for an UL BWP with a nonzero index may include basic BWP parameters (e.g., frequency domain location, bandwidth, subcarrier spacing (SCS), and a cyclic prefix associated with a given cell-specific BWP) and cell-specific parameters for random access, a physical uplink control channel (PUCCH), and a physical uplink shared channel (PUSCH), associated with a given UL BWP.

The BWP dedicated parameters for an UL BWP with a nonzero index may include UE specific parameters for the PUCCH, PUSCH, a sounding reference signal (SRS), a configured grant, and beam failure recovery configurations associated with a given UL BWP.

For unpaired spectrum, for example, the spectrum that may accommodate time division duplex (TDD) operations, in examples where the indices of a DL BPW and an UL BWP are the same, the DL BWP may be linked to the UL BWP. In such an example, the DL BWP and the UL BWP may share a same center frequency; however, according to some aspects, the DL BWP and the UL BWP may have different bandwidths.

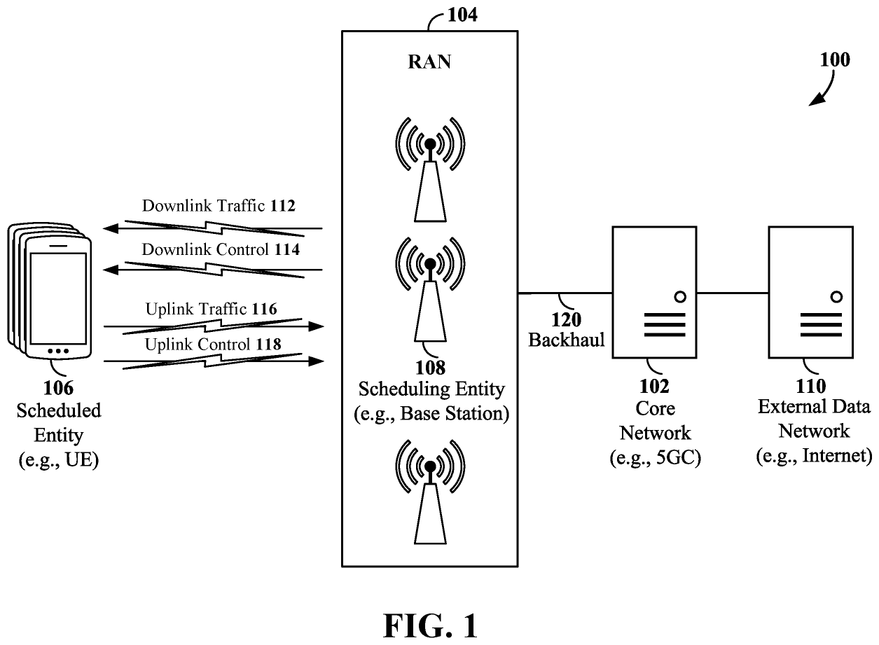

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink control information 118 and/or downlink control information 114 and/or uplink traffic 116 and/or downlink traffic 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base station 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

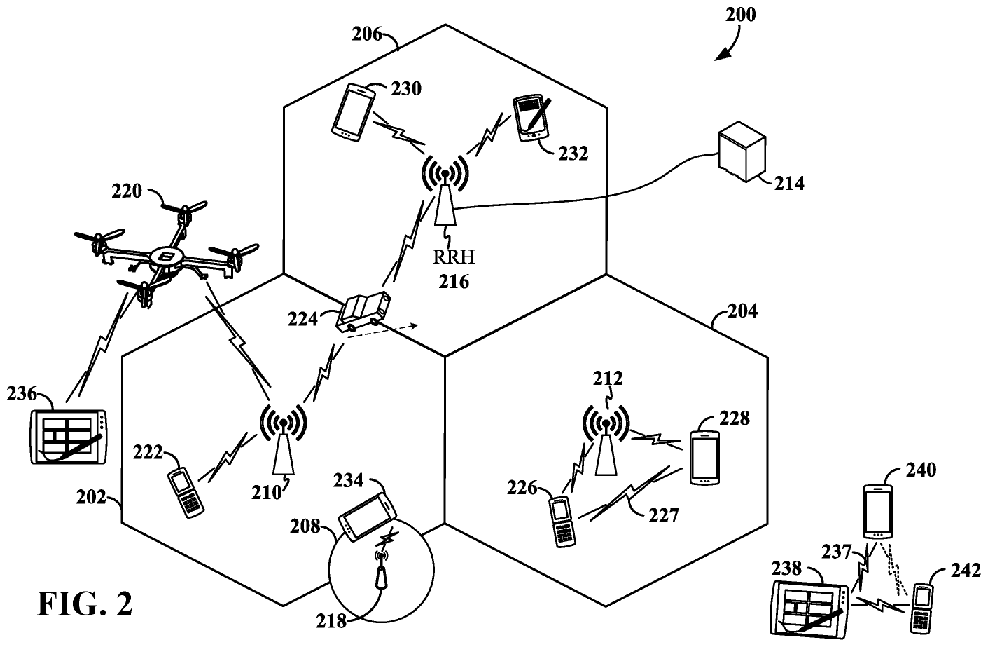

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as subband full-duplex (SBFD), also known as flexible duplex.

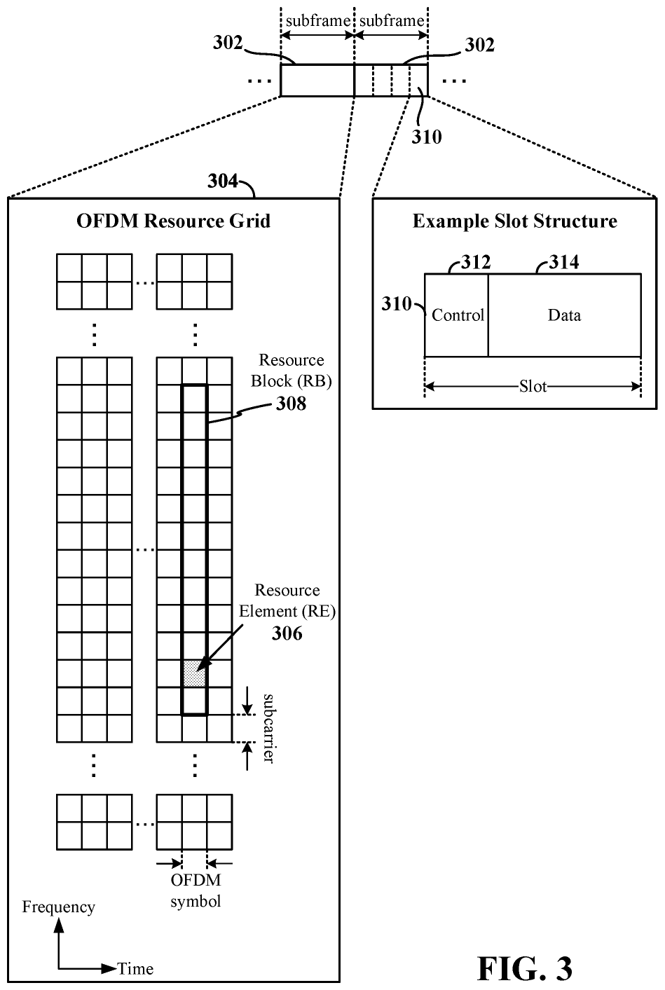

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSB s may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information (e.g., a quantity of the bits of information), may be a controlled parameter, based on the modulation and coding scheme (MCS) and the number of RBs in a given transmission.

The channels or carriers illustrated in FIGS. 1, 2, and 3 are not necessarily all of the channels or carriers that may be utilized between devices, and those of ordinary skill in the art will recognize that other channels or carriers may be utilized in addition to those illustrated, such as other traffic, control, and feedback channels.

According to aspects described herein, uplink and downlink communications may be defined according to time and frequency resources, and may also be defined according to channel-specific configurations. Examples of channel-specific configurations include uplink and downlink configurations utilized with slots scheduled as subband full-duplex (SBFD) slots. Utilization of channel-specific subband configurations (e.g., configurations of subband-specific uplink and subband-specific downlink parameters), may optimize the transmission/reception characteristics of UL/DL SBFD slots, and may reduce any effect of self-interference and/or cross-link-interference in SBFD communications exchanged between a full-duplex gNB and a half-duplex UE according to some aspects of the disclosure.

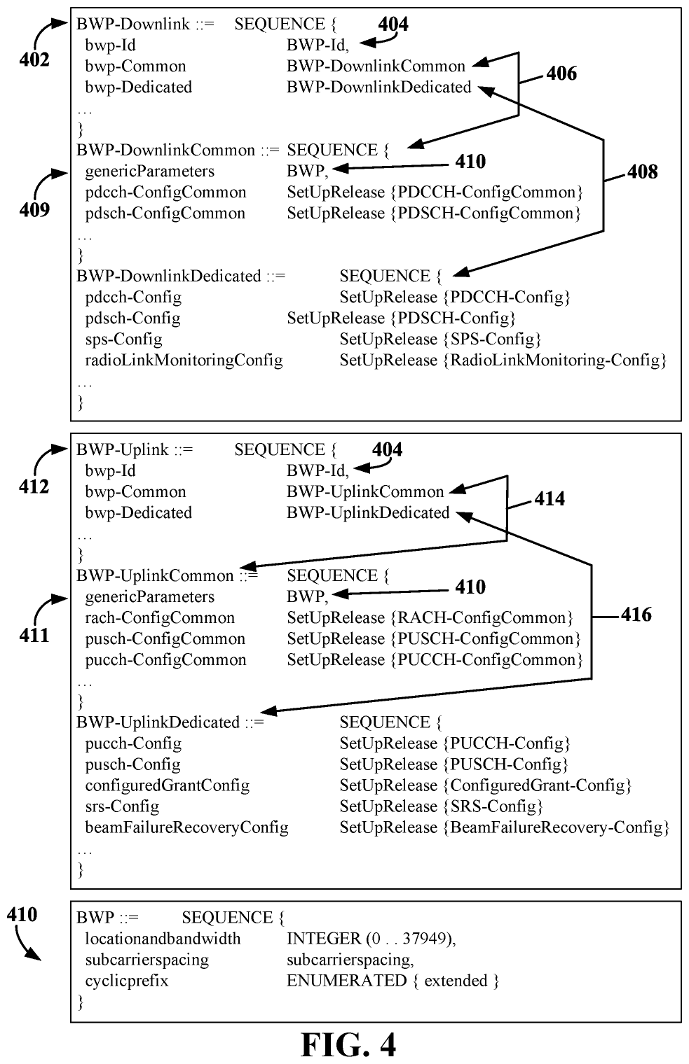

FIG. 4 is a representation of portions of downlink (DL) and uplink (UL) bandwidth part (BWP) configurations according to some aspects of the disclosure. As shown, DL/UL BWP configurations may be divided into common and dedicated parameters. BWP common parameters may be cell specific. As the parameters are cell specific, a network may ensure that the BWP common parameters are distributed to all user equipments (UEs) within a cell (e.g., aligned across all UEs within the cell). BWP-dedicated parameters may be UE specific.

As depicted in FIG. 4, BWP-Downlink 402 parameters may be utilized to specify, for example, a BWP identification (i.e., BWP-Id 404), BWP common parameters (i.e., BWP-DownlinkCommon 406), and BWP dedicated parameters (i.e., BWP-DownlinkDedicated 408). BWP-DownlinkCommon 406 parameters may include, for example, generic parameters 409, such as those described and shown in connection with BWP 410, below. BWP-DownlinkCommon 406 parameters may also include, for example, PDCCH-ConfigCommon and PDSCH-ConfigCommon parameters, which may provide parametric information utilized for the setup and release of a PDCCH and a PDSCH, in general. BWP-DownlinkDedicated 408 parameters may include, for example, PDCCH-Config, PDSCH-Config, semi-persistent scheduling (SPS)-Config, and radioLinkMonitoring-Config parameters, which may all provide parametric information utilized for the setup and release of a PDCCH, PDSCH, as well as provide SPS information and information relevant to radio link monitoring in general. Other parameters, not illustrated in FIG. 4 in connection with the BWP-DownlinkCommon 406 and BWP-DownlinkDedicated 408 parameters, are within the scope of the disclosure.

Also, as depicted in FIG. 4, a BWP-Uplink 412 may be utilized to specify, for example, a BWP identification (i.e., BWP-Id 404 as shown and described in connection with BWP-Downlink 402), BWP common parameters (i.e., BWP-UplinkCommon 414), and BWP dedicated parameters (i.e., BWP-UplinkDedicated 416). BWP-UplinkCommon 414 parameters may include, for example, generic parameters 411, such as those described and shown in connection with BWP 410, below. BWP-UplinkCommon 414 parameters may also include, for example, RACH-ConfigCommon, PUSCH-ConfigCommon, and PUCCH-ConfigCommon parameters, which may provide parametric information utilized during a random access process, and for setup and release of a PUSCH and a PUCCH, in general. BWP-UplinkDedicated 416 parameters may include, for example, PUCCH-Config, PUSCH-Config, Configured Grant (CG)-Config, sounding reference signal (SRS)-Config, and beamFailureRecovery-Config parameters, which may variously provide parametric information utilized for setup and release of a PUSCH, PUCCH, as well as provide SRS information, information relevant to a configured grant, and to beam failure recovery in general. Other parameters, not illustrated in FIG. 4 in connection with the BWP-UplinkCommon 414 and BWP-UplinkDedicated 416 parameters, are within the scope of the disclosure.

Also, as depicted in FIG. 4, the generic information applicable to both common and dedicated BWP configurations may be provided in the BWP 410 parameters as shown at the bottom of FIG. 4. The generic BWP 410 parameters may include, for example, frequency domain location and bandwidth information of a given BWP, where an integer ranging from 0-37949 represents one of 37950 possible combinations of location and bandwidth of the given BWP. The generic BWP 410 parameters also may include a subcarrier spacing parameter, indicative of the subcarrier spacing utilized in connection with the given BWP. The generic BWP 410 parameters also may include a value indicative of a cyclic prefix associated with the given BWP. The preceding lists were exemplary and not limiting.

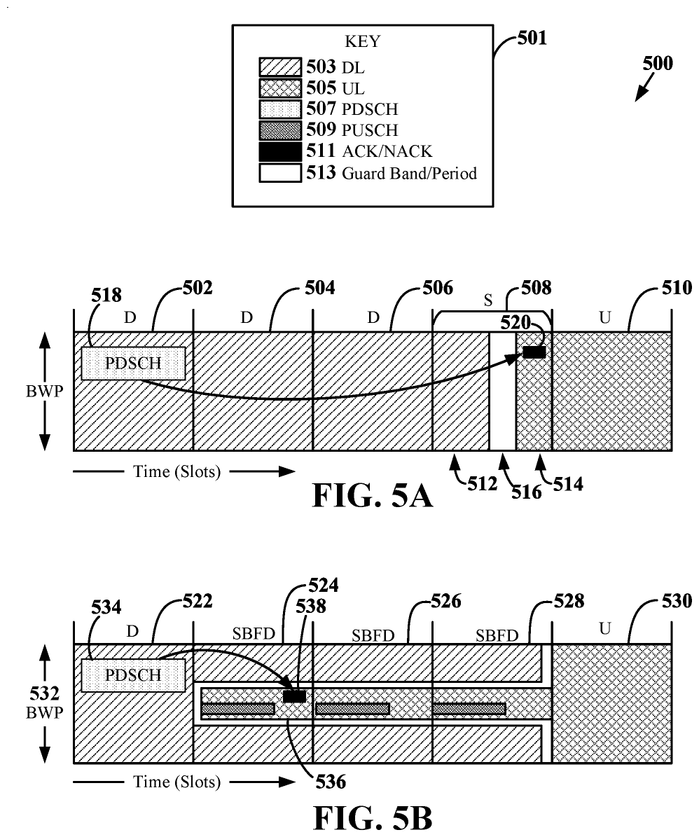

FIGS. 5A and 5B are first and second examples of a plurality of slots 500 utilizing various duplex modes according to some aspects of the disclosure. The key 501 above FIG. 5A applies to both FIG. 5A and FIG. 5B. The key 501 identifies fill-patterns corresponding to DL 503, UL 505, PDSCH 507, PUSCH 509, ACK/NACK 511, and guard band/period 513 locations within the pluralities of slots 500 for ease of reference. FIG. 5A and FIG. 5B may illustrate how a duplex mode known as subband full-duplex (SBFD) was motivated and how SBFD provides a benefit over a time division duplex (TDD) mode of duplexing in which a slot is configured for either uplink or downlink (but not both) and a version of TDD that makes use of a self-contained slot in which non-time overlapped portions of a slot are allocated for uplink or downlink. In both FIG. 5A and FIG. 5B, five slots are depicted for convenience. The alignment of the slots in time is only depicted to aid in a visual comparison of the latency obtainable utilizing a self-contained slot (in FIG. 5A) and the latency obtainable utilizing an SBFD slot (in FIG. 5B).

In FIG. 5A, the first slot 502, the second slot 504, and the third slot 506, and the fifth slot 510 are TDD slots. The first slot 502, the second slot 504, and the third slot 506 are each scheduled for downlink communication (identified using the letter “D”). The fourth slot is a self-contained slot (identified using the letter “S”) and referred to hereinafter as the self-contained slot 508. The self-contained slot 508 may be a slot that includes a downlink part 512, an uplink part 514, and a guard period 516 therebetween. The self-contained slot 508 is a feature introduced in 5G-NR and was not available in long term evolution (LTE). The self-contained slot 508 may provide flexibility by providing, for example, lower latency when compared, for example, to LTE. The fifth slot 510 may be a TDD slot and is scheduled for uplink communication (identified using the letter “U”).

In the example of FIG. 5A, a downlink message conveyed in a PDSCH 518 in the first slot 502 may be transmitted from a network access node (not shown) to a UE (not shown). In the uplink part 514 of the self-contained slot 508, the UE conveys an ACK/NACK 520 indication to the network access node, informing the network access node of the successful or not successful reception of the message conveyed in the PDSCH 518 three slots earlier. Had the fourth slot not been scheduled as a self-contained slot 508, the uplink transmission of the ACK/NACK 520 would have been delayed until the fifth slot 510 (which is scheduled for uplink). Accordingly, latency is improved in FIG. 5A by use of the self-contained slot 508 in comparison to a case where the entirety of the fourth slot might have been scheduled as a downlink slot.

In the example of FIG. 5B, the first 522 and the fifth slot 530 are TDD slots. The first slot 522 is scheduled for downlink communication (identified by the “D”). In the example of FIG. 5B, the second slot 524, the third slot 526, and the fourth slot 528 are scheduled for subband full-duplex (SBFD) communication (identified by the letters “SBFD”). Each of the second slot 524, the third slot 526, and the fourth slot 528 slot may be referred to hereinafter as an SBFD slot. The fifth slot 530 is identified as an uplink slot (identified by the letter “U”).

By utilizing SBFD, portions of the BWP 532 associated with FIG. 5B (e.g., along the vertical axis (frequency axis)) in the second slot 524, the third slot 526, and the fourth slot 528 may be utilized for downlink, while another portion of the BWP 532 may be used for uplink. Accordingly, SBFD may be described as a duplex mode that facilitates simultaneous non-overlapping uplink and downlink portions within a BWP in a given slot. Guard bands are visible above and below the uplink portions of the BWP 532 in the second slot 524, third slot 526, and fourth slot 528. A guard period is visible between the first slot 522 and the second slot 524, adjacent to the portions of the BWP 532 that change from downlink to uplink, and between the fourth slot 528 and the fifth slot 530 adjacent to the portions of the BWP 532 that change from downlink to uplink.

In the example of FIG. 5B, a downlink message conveyed in a PDSCH 534 in the first slot 522 may be transmitted from a network access node (not shown) to a UE (not shown). In the uplink part 536 of the SBFD slot (the second slot 524), the UE conveys an ACK/NACK 538 indication to the network access node, informing the network access node of the successful or not successful reception of the message conveyed in the PDSCH 534 in the immediately preceding slot (the first slot 522). Had the second slot 524 not been scheduled as an SBFD slot, the uplink transmission of the ACK/NACK 538 would have been delayed until the fifth slot 530 (which is scheduled for uplink). Accordingly, latency is improved in FIG. 5B by use of the SBFD slot (i.e., the second slot 524) in comparison to both the case where the entirety of the second slot 524, the third slot 526, and the fourth slot 528 might have been scheduled for downlink, and in comparison to the use of the self-contained slot 508 as shown and described in connection with FIG. 5A.

Accordingly, utilizing SBFD may lower latency, for example, by enabling a faster conveyance of channel state information (CSI) or more rapid hybrid automatic repeat request (HARQ) feedback and, for example, by enabling an improved UL duty cycle and latency reduction (e.g., in comparison to systems that use TDD with or without self-contained slots, but do not use SBFD). The improved UL duty cycle and latency reduction may be especially evident for small packets (interchangeable with universal personal telecommunication (UPT)). Subband full-duplex may provide larger UL coverage and capacity, for example, due to a coverage gain for cell edge with repetition. Still further, subband full-duplex may also enable flexible UL/DL resource allocation by providing a multiplexing mode that may robustly adapt to different traffic.

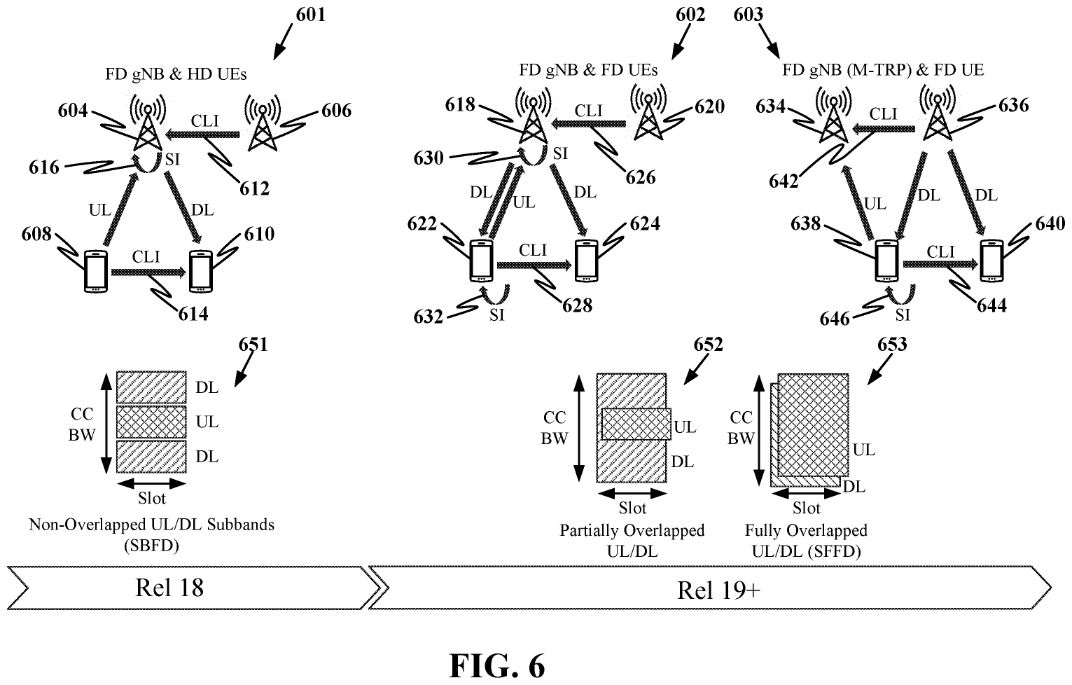

FIG. 6 is a schematic representation of a plurality of full-duplex gNBs, half-duplex UEs, and full-duplex UEs, and a corresponding graphical depiction of time-frequency resources for uplink and downlink transmissions according to some aspects of the disclosure. In FIG. 6, non-overlapped uplink and downlink subbands 651 (e.g., SBFD), partially overlapped uplink and downlink 652 bands, and fully overlapped uplink and downlink 653 bands (also known as single frequency full-duplex (SFFD)) are illustrated.

In a first example 601, a first full-duplex (FD) gNB 604, a second FD gNB 606, a first half-duplex (HD) UE 608, and a second HD UE 610 are depicted according to some aspects of the disclosure. Non-overlapping uplink and downlink subbands 651 (i.e., SBFD as described and illustrated in connection with FIG. 5B) are utilized for uplink (UL) communication from the first HD UE 608 to the first FD gNB 604 and for downlink (DL) communication from the first FD gNB 604 to the second HD UE 610. A first example of cross-link interference (CLI) 612 exists between the first FD gNB 604 and the second FD gNB 606. A second example of CLI 614 exists between the first HD UE 608 and the second HD UE 610. Additionally, due to the full-duplex nature of the first FD gNB 604, self-interference (SI) 616 is shown as being present in connection with the first FD gNB 604.

In a second example 602, a first full-duplex (FD) gNB 618, a second FD gNB 620, a first full-duplex (FD) UE 622, and a second FD UE 624 are depicted according to some aspects of the disclosure. Partially overlapping uplink and downlink 652 bands and fully overlapping 653 bands (i.e., SFFD) may be utilized for uplink (UL) communication from the first FD UE 622 to the first FD gNB 618 and downlink (DL) communications from the first FD gNB 618 to the first FD UE 622 and the second FD UE 624. A first example of cross-link interference (CLI) 626 exists between the first FD gNB 618 and the second FD gNB 620. A second example of CLI 628 exists between the first FD UE 622 and the second FD UE 624. Additionally, due to the full-duplex nature of the first FD gNB 618, a first self-interference (SI) 630 is shown as being present in connection with the first FD gNB 618. Additionally, due to the partial or full overlap duplex modes of the first FD UE 622, a second self-interference (SI) 632 is shown as being present in connection with the first FD UE 622.

In a third example 603, a first full-duplex (FD) gNB 634 (serving as a first transmit-receive point (TRP) of a multi-TRP (M-TRP) configuration of gNBs), a second FD gNB 636 (serving as a second TRP of the M-TRP configuration of gNBs), a first FD UE 638, and a second FD UE 640 are depicted according to some aspects of the disclosure. Partially overlapping uplink and downlink 652 bands or fully overlapping 653 bands (i.e., SFFD) may be utilized for uplink (UL) communication from the first FD UE 638 to the first FD gNB 634 (the first M-TRP node) and downlink (DL) communications from the second FD gNB 636 (the second M-TRP node) to the first FD UE 638 and the second FD UE 640. A first example of cross-link interference (CLI) 642 exists between the first FD gNB 634 and the second FD gNB 636 (i.e., between the two TRPs of the M-TRP configuration). A second example of CLI 644 exists between the first FD UE 638 and the second FD UE 640. Additionally, due to the partial or full overlap duplex modes of the first FD UE 638, a self-interference (SI) 646 is shown as being present in connection with the first FD UE 638.

The duplex mode having non-overlapping uplink and downlink subbands 651 (i.e., SBFD) may be utilized in 5G communications according to, for example, Release 18 of certain 3GPP standards. The duplex modes having partially overlapped uplink and downlink 652 bands or fully overlapping 653 bands (i.e., SFFD) may be utilized in 5G communications beginning, for example, with Release 19 of certain 3GPP standards.

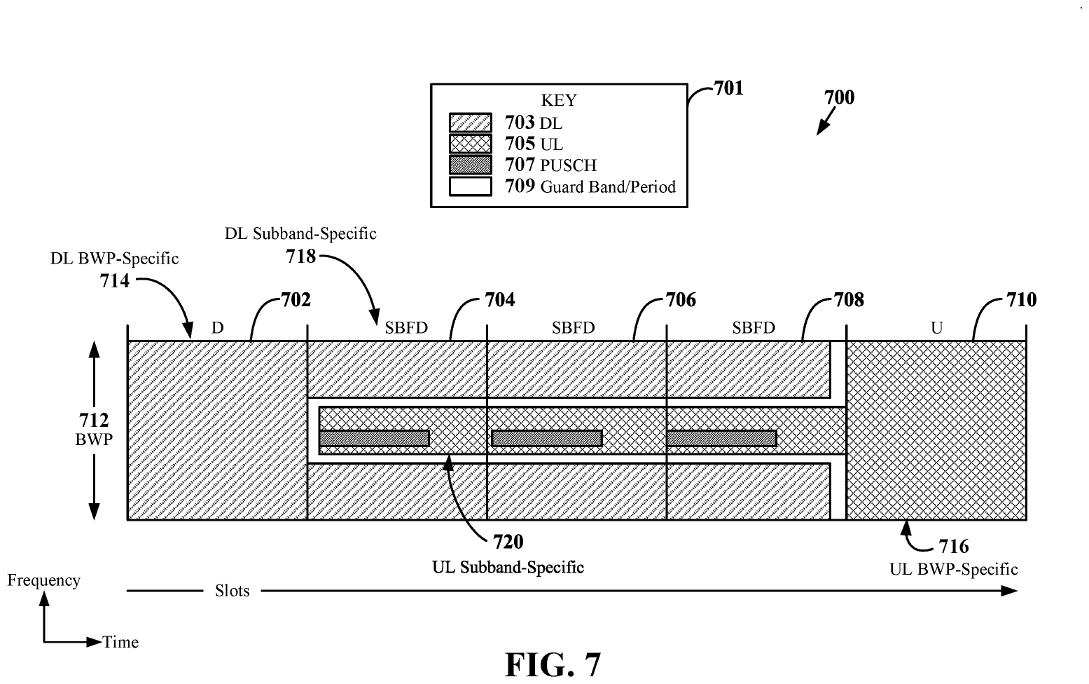

FIG. 7 is an example of a plurality of slots, including slots scheduled for subband full-duplex communications according to some aspects of the disclosure. In FIG. 7, a first slot 702 is identified as a downlink slot, a second slot 704 is identified as an SBFD slot, a third slot 706 is identified as an SBFD slot, and a fourth slot 708 is also identified as an SBFD slot. The fifth slot 710 is identified as an uplink slot. In the second-fourth slots 704-708, utilizing SBFD, portions of the BWP 712 in the second slot 704, the third slot 706, and the fourth slot 708 may be utilized for downlink, while another portion of the BWP 712 may be used for uplink. Accordingly, SBFD may be described as a duplex mode that facilitates non-overlapping uplink and downlink portions within a BWP 712 in a given slot. Guard bands are visible above and below the uplink portions of the BWP 712 in the second slot 704, third slot 706, and fourth slot 708. A guard period is visible between the first slot 702 and the second slot 704, adjacent to the portions of the BWP 712 that change from downlink to uplink and between the fourth slot 708 and the fifth slot 710 adjacent to the portions of the BWP 712 that change from downlink to uplink.

Also, in FIG. 7, it is noted that the first slot 702 may be configured according to DL-BWP-specific configuration parameters, for example, such as the BWP-Downlink 402 parameters as shown and described in connection with FIG. 4. It is noted that the fifth slot 710 may be configured according to UL-BWP-specific configuration parameters, for example, such as the BWP-Uplink 412 parameters as shown and described in connection with FIG. 4.

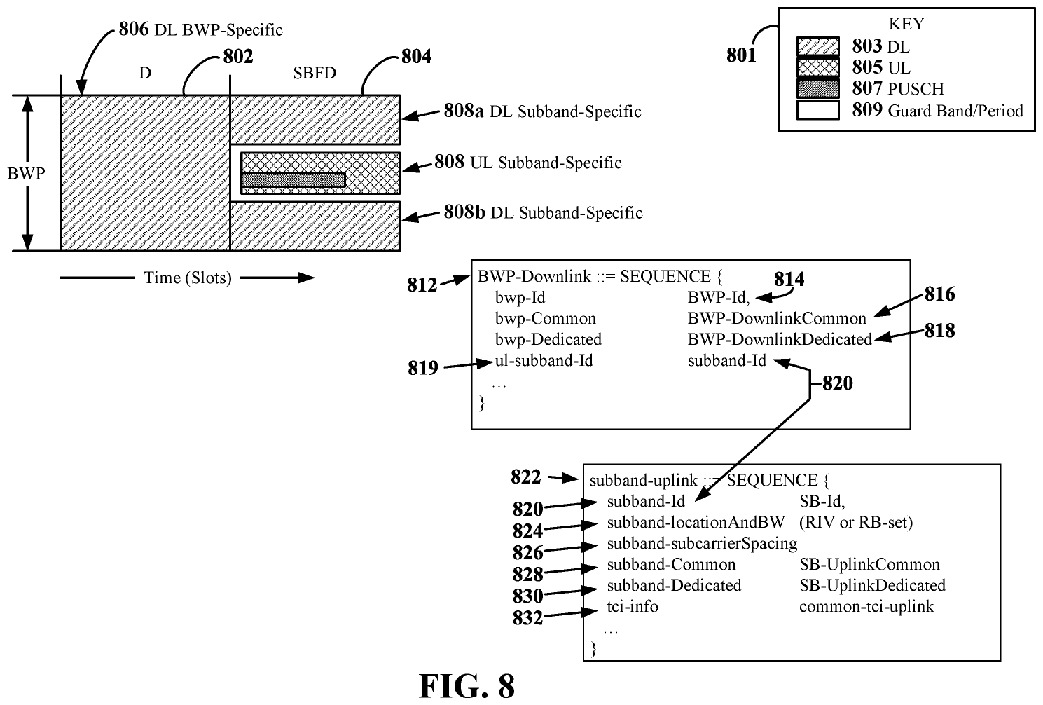

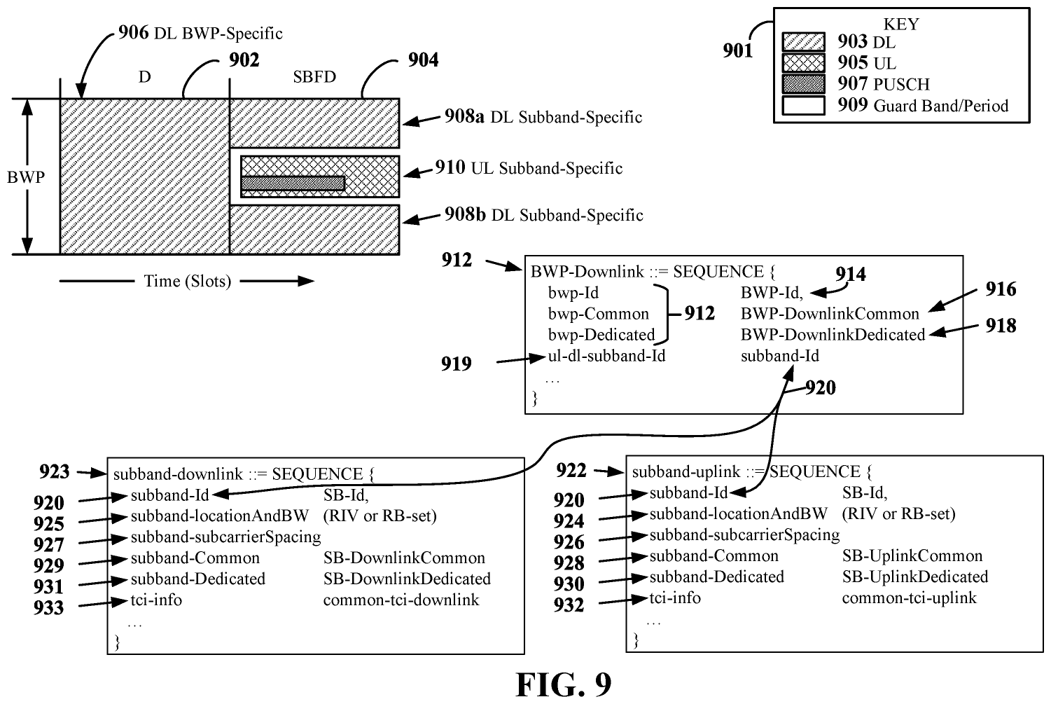

Still further in FIG. 7, it is noted that the DL portions of the second slot 704 (and the third and fourth slots 706, 708) may be configured according to a DL subband-specific 718 configuration parameters and the UL portion of the second slot 704 (and the third and fourth slots 706, 708) may be configured according to a UL subband-specific 720 configuration parameters. The subband-specific parameters (both DL and UL related) are described in connection with FIGS. 8 and 9, below.

In the examples of FIG. 6, the use of SBFD in conjunction with FD gNBs and HD UEs may result in, for example, a difference in DL QoS between a DL TDD slot (i.e., single direction slot) and a DL-SBFD slot due to the presence of inter-UE CLI (e.g., CLI 614 of FIG. 6). By way of another example, there may be a difference in UL QoS between a UL TDD slot (i.e., single direction slot) and an UL-SBFD slot due to the presence of gNB self-interference (e.g., SI 616 of FIG. 6) and inter-gNB CLI (e.g., CLI 612 of FIG. 6).

To accommodate for the differences in link quality, it may be beneficial and/or useful to define SBFD-specific uplink (referred to herein as subband-specific uplink) and SBFD-specific downlink (referred to herein as subband-specific downlink) channel and/or signal configurations. These configurations may be separate from those defined within the BWP, such as those described above in connection with FIG. 4.

According to some examples, these configurations (which may include unique channel configurations and/or reference signal configurations) may be used when a FD gNB and a HD UE communicate using subband full-duplex.

According to aspects described herein, UL and DL may be defined according to time and frequency and may also be defined according to channel-specific configurations (e.g., subband-specific uplink and subband-specific downlink parameters). By use of the channel-specific subband configurations (e.g., subband-specific uplink and subband-specific downlink parameters), the transmission/reception in UL/DL SBFD may be optimized to handle the frequency resources of the UL/DL SBFD and may also be optimized in terms of link requirements (e.g., power, timing, transceiver control interface (TCI), etc.) and thereby be optimized to reduce effects of self-interference and/or cross-link interference at both nodes (i.e., at both the FD gNB and the HD UE). Examples of portions of slots to which DL subband-specific parameter and UL subband-specific parameters may be applied are presented in connection with FIG. 7.

FIG. 7 is an example of five slots, where the first slot 702 is scheduled as a downlink (D) slot (using TDD). The second slot 704, the third slot 706, and the fourth slot 708 are scheduled as subband full-duplex (SBFD) slots. The fifth slot 710 is scheduled as an uplink (U) slot (using TDD). In the first slot 702, DL-BWP-specific 714 parameters may be configured to the UE (not shown) by a gNB (not shown). In the second slot 704, the third slot 706, and the fourth slot 708, in the downlink portions of those slots, DL subband-specific 718 parameters may be configured to the UE, while in the uplink portions, UL subband-specific 720 parameters may be configured to the UE. In the fifth slot 710, UL-BWP-specific 716 parameters may be configured to the UE by the gNB.

Described herein may be UL/DL subband-specific configurations, where subband-specific parameters may be conveyed via radio resource connection (RRC) signaling according to some aspects herein. The various UL/DL subband-specific configuration options may be configured to one or more half-duplex user equipments by a full-duplex network access node (e.g., a gNB, a scheduling entity). Separate RRC parameters may be configured for each downlink and uplink subband.

In one example, a gNB may configure a UE with subband-specific RRC parameters for the transmission/reception of a channel and/or signal of that subband. In one aspect, there may be separate RRC parameters for each DL and UL subband.

According to some examples, there may be at least three options for the RRC parameter. For example, a first option may entail the use of subband common parameters which are cell-specific (e.g., common to all UEs in a given cell). In this example, it may be implied that the network (e.g., the network access node, the gNB, the scheduling entity) ensures that the subband common parameters are aligned across the UEs within the given cell.

A second option may entail that the subband-specific parameters may be dedicated (which may be referred to herein as subband-dedicated specific parameters) (e.g., the subband-specific parameters may be specific to a given UE, also described as a UE dedicated configuration).

A third option may entail that both common and dedicated subband-specific configurations may be used.

For DL subband: the RRC parameters may include, for example, PDSCH, PDCCH and SPS configuration+DL-SB time and frequency (T/F) indication.

For UL subband: the RRC parameters may include, for example, PUSCH, PUCCH, CG, SRS and PRACH configurations+UL-SB T/F indication.

The RRC parameters may indicate SB-specific configurations dedicated for specific channels and/or signals.

In one example of UL subband, a gNB may configure an SBFD-specific PUCCH resource set (or resources) configured with a specific hopping pattern, repetition factor, frequency allocation and open-loop power control parameters, for example.

In one example of DL subband, a gNB may configure an SBFD-specific CSI-RS for channel measurement that is non-contiguous, or may configure CLI-specific resources for computation of CLI metrics at SBFD slots.

According to one aspect, the RRC parameters may be indicated as subband-specific parameters for all signals and channels (e.g., time advance or common TCI (a.k.a., unfired TCI state)).

A FD gNB (e.g., first FD gNB 604 as shown and described in connection with FIG. 6) may have various ways to indicate an UL/DL subband-specific configuration to a HD UE (e.g., first HD UE 608 as shown and described in connection with FIG. 6).

FIG. 8 is an example of a first slot 802 and a second slot 804, along with parametric data that may be used to configure the first slot 802 (configured as a downlink slot) and the second slot 804 (configured as an SBFD slot) according to some aspects of the disclosure. A key 801 identifies fill-patterns corresponding to DL 803, UL 805, PUSCH 807, and guard band/period 809 locations within the first slot 802 and the second slot 804 for ease of reference.

In the first slot 802, DL-BWP-specific 806 parameters may be configured to a UE (not shown) by a gNB (not shown). In the second slot 804, in the downlink portions of the slot, DL subband-specific 808a, 808b parameters may be configured to the UE, while in the uplink portion of the slot, UL subband-specific 810 parameters may be configured to the UE.

According to some aspects, when a gNB configures a downlink, the DL-BWP-specific configuration (e.g., BWP-Downlink 812) may be associated with an UL subband-specific configuration (e.g., subband-uplink 822). The BWP-Downlink 812 parameters may include a BWP identification (BWP-Id 814), BWP common parameters (BWP-DownlinkCommon 816), BWP dedicated parameters (BWP-DownlinkDedicated 818), and an uplink subband identifier (subband-Id 820). The subband-uplink 822 parameters may include an identifier for UL subband-specific parameters (ul-subband-Id 819 indicated as subband-Id 820). The subband-uplink 822 parameters may include, for example, subband-Id 820, subband-locationAndBW 824, subband-subcarrierSpacing 826, subband-Common 828, subband-Dedicated 830, and tci-info 832.

Similarly, when the gNB configures an uplink, the UL-BWP-specific configuration (not shown) may be associated with a DL subband-specific configuration (not shown). In the former case, the association may be either by having ul-subband-Id 819 as a parameter within the BWP-Downlink 812 configuration or by having all the UL subband-specific configurations under the DL BWP (i.e., within the BWP-Downlink 812).

FIG. 9 is an example of a first slot 902 and a second slot 904, along with parametric data that may be used to configure the first slot 902 (configured as a downlink slot) with DL BWP-specific 906 parameters and the second slot 904 (configured as an SBFD slot) with DL subband-specific 908a, 908b and UL subband-specific 910 parameters, according to some aspects of the disclosure. In examples where a gNB configures a DL BWP (e.g., BWP-Downlink 912), the BWP-Downlink 912 may be associated with an UL subband-specific 910 and DL subband-specific 908a, 908b pair of configurations. In one example, the association could be made by having subband-Id 920 as a parameter within the BWP-Downlink 912, where subband-Id 920 indicates both the UL subband-specific 910 and the DL subband-specific 908a, 908b configurations. A key 901 identifies fill-patterns corresponding to DL 903, UL 905, PUSCH 907, and guard band/period 909 locations.

The BWP-Downlink 912 parameters may include, for example, BWP-Id 914, BWP-DownlinkCommon 916, and BWP-DownlinkDedicated 918. The BWP-Downlink 912 parameters may also include an identifier for both UL subband-specific 910 and DL subband-specific 908a, 908b parameters (e.g., the ul-dl-subband-Id 919 indicated as subband-Id 920 (i.e., a subband identifier)). The ul-dl-subband-Id 919 associates both the UL subband-specific 910 parameters (e.g., subband-uplink 922 parameters) and the DL subband-specific parameters (e.g., subband-downlink 923 parameters). Accordingly, the identifier subband-Id 920 may correspond to subband-uplink 922 parameters and subband-downlink 923 parameters.

The subband-uplink 922 parameters may include, for example, subband-Id 920, subband-locationAndBW 924, subband-subcarrierSpacing 926, subband-Common 928, subband-Dedicated 930, and tci-info 932. The subband-downlink 923 parameters may include, for example, subband-Id 920, subband-locationAndBW 925, subband-subcarrierSpacing 927, subband-Common 929, subband-Dedicated 931, and tci-info 933.

UE behavior with regard to subband and BWP channel and signal configurations is now described. When a UE is scheduled (DCI, higher-layer, or MAC-CE) for UL transmission in an SBFD slot, the UE may use the channels/signal configured under the UL subband-specific 910 configuration parameters (if configured); otherwise, the UE may use the UL channel/signal configuration under a UL BWP-specific configuration By way of example, a UE may receive UL DCI (e.g., format 0_1 or 0_2) scheduling a PUSCH with repetition across SBFD slots. Then the UE may use a PUSCH-config under UL subband-specific 910 configuration parameters for a PUSCH related configuration (where examples of the PUSCH related configuration may include, for example, TDRA, frequency hopping, power-control, MCS table, etc.).

In another example, in response to being scheduled (e.g., in a DCI or higher-layer, or MAC-CE) for DL reception in SBFD, the UE may use the channel/signals configured under DL subband-specific 908a, 908b configuration parameters (if configured). Otherwise, the UE may use the DL channel/signal configured under the DL BWP-specific 906 configuration. By way of example a UE may receive DL DCI (e.g., format 1_1 or 1_2) scheduling PDSCH with repetition across SBFD slots. The UE may use the PDSCH-config under DL subband-specific 908a, 908b configuration parameters for a PDSCH related configuration (e.g., TDRA, frequency hopping, MCS table, etc.).

For UEs that may use TDD but not SBFD, the TDD DL and UL slot/symbol may be indicated to the UE by a dedicated/common RRC configuration (e.g., a TDD pattern). The UE may use the DL/UL signal/channel within the DL/UL BWP configuration.

For a flexible symbol/slot, the UE may use the BWP configuration unless the DCI includes a bit indicating the use of an SBFD mode (then UE may use the UL/DL SB configurations).

Note: SBFD symbol/slot is from a gNB perspective and is indicated to the UE by SBFD RRC signaling. The slot/symbol is configured as DL/UL or flexible (UL-DL TDD pattern).

For other periodic (P) or semi-persistent (SP), UL or DL channel or reference signal configurations (e.g., SPS, CG, SRS, CSI-RS, etc.) configured within the UL/DL subband; when one instance occurs in a non-SBFD slot, then the configuration is dropped or canceled for that non-SBFD slot.

For dynamic grant (DG) (DCI-based) including aperiodic (AP) reference signal (RS) (e.g., aperiodic-SRS (A-SRS) and aperiodic CSI-RS (A-CSI-RS)), the gNB may send DCI targeting the appropriate configuration of the slot and corresponding signal/channel.

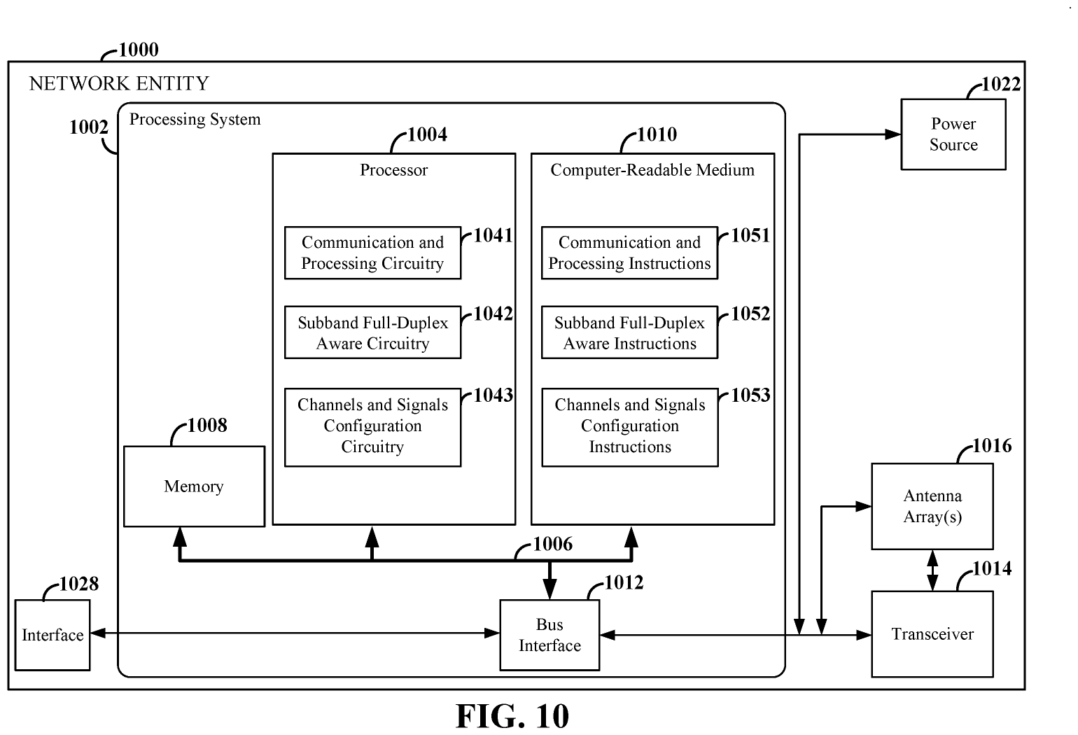

FIG. 10 is a block diagram illustrating an example of a hardware implementation of a network access node 1000 (e.g., a gNB, a base station, a TRP, a scheduling entity) employing a processing system 1002 according to some aspects of the disclosure. The network access node 1000 may be similar to any one or more of the network access nodes illustrated and described in FIGS. 1, 2, and/or 6.

In accordance with various aspects of the disclosure, an element, or any portion of an element, or any combination of elements may be implemented with a processing system 1002 that includes one or more processors, such as processor 1004. Examples of processors 1004 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the network access node 1000 may be configured to perform any one or more of the functions described herein. That is, the processor 1004, as utilized in the network access node 1000, may be used to implement any one or more of the methods or processes described and/or illustrated, for example, in any one or more of FIGS. 5, 6, 7, 8, and/or 9.

The processor 1004 may, in some examples, be implemented via a baseband or modem chip, and in other implementations, the processor 1004 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 1002 may be implemented with a bus architecture, represented generally by the bus 1006. The bus 1006 may include any number of interconnecting buses and bridges depending on the specific application of the processing system 1002 and the overall design constraints. The bus 1006 couples together (e.g., communicatively couples) various circuits, including one or more processors (represented generally by the processor 1004), a memory 1008, and computer-readable media (represented generally by the computer-readable medium 1010). The bus 1006 may also link various other circuits such as timing sources, peripherals, voltage regulators, and power management circuits, which are well known in the art, and, therefore, will not be described any further.

A bus interface 1012 provides an interface between the bus 1006 and one or more transceivers (represented generally by transceiver 1014). The transceiver 1014 may be a wireless transceiver. The transceiver 1014 may provide a means for communicating with various other apparatus over a transmission medium (e.g., air interface). The transceiver 1014 may further be coupled to an antenna array(s) 1016.

The bus interface 1012 further provides an interface between the bus 1006 and a user interface 1028 (e.g., keypad, display, touch screen, speaker, microphone, control features, etc.). Of course, such a user interface 1028 is optional and may be omitted in some examples. In addition, the bus interface 1012 further provides an interface between the bus 1006 and a power source 1022 of the network access node 1000.

The processor 1004 is responsible for managing the bus 1006 and general processing, including the execution of software stored on the computer-readable medium 1010. The software, when executed by the processor 1004, causes the processing system 1002 to perform the various functions described below for any particular apparatus. The computer-readable medium 1010 and the memory 1008 may also be used for storing data that is manipulated by the processor 1004 when executing software.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 1010. When executed by the processor 1004, the software may cause the processing system 1002 to perform the various processes and functions described herein for any particular apparatus.

The computer-readable medium 1010 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 1010 may reside in the processing system 1002, external to the processing system 1002, or distributed across multiple entities including the processing system 1002. The computer-readable medium 1010 may be embodied in a computer program product or article of manufacture. By way of example, a computer program product or article of manufacture may include a computer-readable medium in packaging materials. In some examples, the computer-readable medium 1010 may be part of the memory 1008. Those skilled in the art will recognize how best to implement the described functionality presented throughout this disclosure depending on the particular application and the overall design constraints imposed on the overall system.

In some aspects of the disclosure, the processor 1004 may include communication and processing circuitry 1041 configured for various functions, including, for example, communicating with user equipment (e.g., wireless communication device, mobile devices, scheduled entities), a network core (e.g., a 5G core network), or any other entity, such as, for example, an entity communicating with the network access node 1000 via the Internet, such as a network provider. In some examples, the communication and processing circuitry 1041 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 1041 may include one or more transmit/receive chains.

In some implementations where the communication involves receiving information, the communication and processing circuitry 1041 may obtain or identify information from a component of the network access node 1000 (e.g., from the transceiver 1014 that receives the information via radio frequency signaling or some other type of signaling suitable for the applicable communication medium), process (e.g., decode) the information, and output the processed information. For example, the communication and processing circuitry 1041 may output the information to another component of the processor 1004, to the memory 1008, or to the bus interface 1012. In some examples, the communication and processing circuitry 1041 may receive one or more of: signals, messages, other information, or any combination thereof. In some examples, the communication and processing circuitry 1041 may receive information via one or more channels. In some examples, the communication and processing circuitry 1041 may include functionality for a means for receiving. In some examples, the communication and processing circuitry 1041 may include functionality for a means for processing, including a means for demodulating, a means for decoding, etc.

In some implementations where the communication involves sending (e.g., transmitting) information, the communication and processing circuitry 1041 may obtain or identify information (e.g., from another component of the processor 1004, the memory 1008, or the bus interface 1012), process (e.g., modulate, encode, etc.) the information, and output the processed information. For example, the communication and processing circuitry 1041 may obtain data stored in the memory 1008 and may process the obtained data according to some aspects of the disclosure.

In some examples, the communication and processing circuitry 1041 may obtain information and output the information to the transceiver 1014 (e.g., transmitting the information via radio frequency signaling or some other type of signaling suitable for the applicable communication medium). In some examples, the communication and processing circuitry 1041 may send one or more of signals, messages, other information, or any combination thereof. In some examples, the communication and processing circuitry 1041 may send information via one or more channels. In some examples, the communication and processing circuitry 1041 may include functionality for a means for sending (e.g., a means for transmitting).

In some examples, the communication and processing circuitry 1041 may include functionality for a means for generating, including a means for modulating, a means for encoding, etc. In some examples, the communication and processing circuitry 1041 may be configured to receive and process uplink traffic and uplink control messages (e.g., similar to uplink traffic 116 and uplink control information 118 of FIG. 1) and process and transmit downlink traffic and downlink control messages (e.g., similar to downlink traffic 112 and downlink control information 114 of FIG. 1) via the antenna array(s) 1016 and the transceiver 1014.

The communication and processing circuitry 1041 may further be configured to execute communication and processing instructions 1051 (e.g., software) stored on the computer-readable medium 1010 to implement one or more functions described herein.

In some aspects of the disclosure, the processor 1004 may include subband full-duplex aware circuitry 1042. The subband full-duplex aware circuitry 1042 may be configured for various functions, including, for example, receiving an indication that a user equipment is aware of subband full-duplex operation of the network access node 1000. The subband full-duplex aware circuitry 1042 may be configured to execute subband full-duplex aware instructions 1052 (e.g., software), stored, for example, on the computer-readable medium 1010, to implement one or more functions described herein.

In some aspects of the disclosure, the processor 1004 may include channels and signals configuration circuitry 1043. The channels and signals configuration circuitry 1043 may be configured for various functions, including, for example, transmitting, in response to receiving the indication of subband full-duplex awareness from the UE, at least one of a downlink subband-specific channels and signals configuration or an uplink subband-specific channels and signals configuration utilizing radio resource control (RRC) signaling.

According to some aspects, the downlink subband-specific channels and signals configuration comprises at least one of: subband common parameters that are cell specific, subband dedicated parameters that are user equipment specific, or a combination of the subband common parameters and the subband dedicated parameters. In some examples, the subband common parameters that are cell specific or the subband common parameters that are user equipment specific may be configured per cell or per bandwidth part (BWP), respectively. In some examples multiple subband configurations may be configured and each subband configuration may be labeled with an identifier (ID).

In some examples, the RRC signaling associated with the downlink subband-specific channels and signals configuration may include: at least one of: physical downlink shared channel configuration parameters, physical downlink control channel configuration parameters, a semi-persistent scheduling configuration parameter, or a downlink subband timing and frequency indication parameter; and the RRC signaling associated with the uplink subband-specific channels and signals configuration may include: at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter.

According to some aspects, the RRC signaling may include a parameter indicating that the downlink subband-specific channels and signals configuration or the uplink subband-specific channels and signals configuration is dedicated to a specific channel or a specific signal. In some examples, processor 1004, or the channels and signals configuration circuitry 1043, may be further configured to: transmit RRC signaling, including a parameter indicating a subband full-duplex specification that is common to all signals and channels. In some examples, the subband full-duplex specification is at least one of a timing advance parameter or a unified transmission configuration indicator state.

In some examples, processor 1004, or the channels and signals configuration circuitry 1043, may be further configured to at least one of: transmit a downlink bandwidth part configuration associated with the uplink subband-specific channels and signals configuration, or transmit an uplink bandwidth part configuration associated with the downlink subband-specific channels and signals configuration. According to some aspects, an association may be established by including a subband identifier (e.g., ul-subband-Id, ul-dl-subband-Id) within the at least one of: the downlink bandwidth part configuration to associate the downlink bandwidth part configuration with the uplink SBFD-specific channels and signals configuration, or the uplink bandwidth part configuration, to associate the uplink bandwidth part configuration with the downlink SBFD-specific channels and signals configuration, respectively.

In some examples, the downlink subband-specific channels and signals configuration and the uplink subband-specific channels and signals configuration together may comprise a downlink-uplink subband-specific pair, and the processor 1004, or the channels and signals configuration circuitry 1043, may be further configured to: transmit a downlink bandwidth part configuration in association with the downlink-uplink subband-specific pair.

In some examples, the downlink subband-specific channels and signals configuration is distinct from both a bandwidth part downlink common configuration and a bandwidth part downlink dedicated configuration, and the uplink subband-specific channels and signals configuration is distinct from both a bandwidth part uplink common configuration and a bandwidth part uplink dedicated configuration.

The channels and signals configuration circuitry 1043 may be configured to execute channels and signals configuration instructions 1053 (e.g., software), stored, for example, on the computer-readable medium 1010 to implement one or more functions described herein.

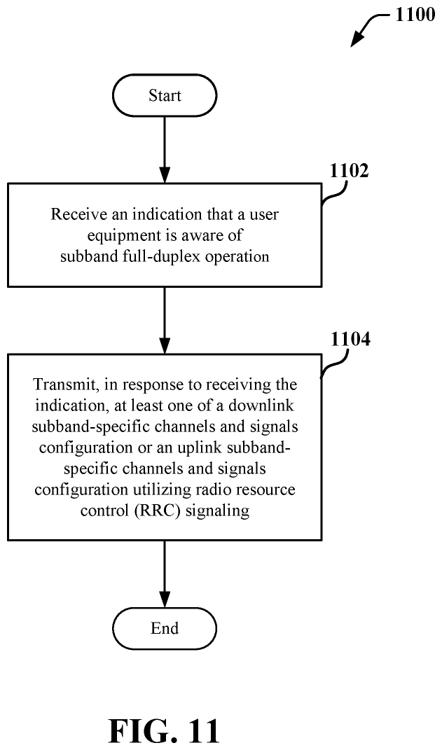

FIG. 11 is a flow chart illustrating an exemplary process 1100 (e.g., a method of wireless communication) at a network access node (e.g., a gNB, a base station, a TRP, a scheduling entity) according to some aspects of the disclosure. The process 1100 may occur in a wireless communication network, such as the wireless communication networks of FIGS. 1, 2, and/or 6, for example. As described below, some or all illustrated features may be omitted in a particular implementation within the scope of the present disclosure, and some illustrated features may not be required for all implementations. In some examples, the process 1100 may be carried out by the network access node 1000 described and illustrated in connection with FIG. 10. In some examples, the process 1100 may be carried out by any suitable apparatus or means for carrying out the functions or algorithms described herein.

At block 1102, the network access node may receive an indication that a user equipment is aware of subband full-duplex operation. For example, the subband full-duplex aware circuitry 1042, in conjunction with, for example, the transceiver 1014 and antenna array(s) 1016, all as shown and described in connection with FIG. 10, may provide a means for receiving an indication that a user equipment is aware of subband full-duplex operation.

At block 1104, the network access node may transmit, in response to receiving the indication, at least one of a downlink subband-specific channels and signals configuration or an uplink subband-specific channels and signals configuration utilizing radio resource control (RRC) signaling. For example, the channels and signals configuration circuitry 1043, as shown and described in connection with FIG. 10, may provide a means for transmitting, in response to receiving the indication, at least one of a downlink subband-specific channels and signals configuration or an uplink subband-specific channels and signals configuration utilizing radio resource control (RRC) signaling.

According to some aspects, the downlink subband-specific channels and signals configuration may include at least one of: subband common parameters that are cell specific, subband dedicated parameters that are user equipment specific, or a combination of the subband common parameters and the subband dedicated parameters. In some examples, the parameters may be configured per bandwidth part (BWP) or configured per cell. In some examples, multiple subband configurations may be configured, and each subband configuration may be labeled with an identifier (ID). According to some aspects, the RRC signaling associated with the downlink subband-specific channels and signals configuration may include: at least one of: physical downlink shared channel configuration parameters, physical downlink control channel configuration parameters, a semi-persistent scheduling configuration parameter, or a downlink subband timing and frequency indication parameter; and the RRC signaling associated with the uplink subband-specific channels and signals configuration may include: at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter. In some examples, the RRC signaling may include a parameter indicating that the downlink subband-specific channels and signals configuration or the uplink subband-specific channels and signals configuration may be dedicated to a specific channel or a specific signal.

In some examples, the channels and signals configuration circuitry 1043, in conjunction with the transceiver 1014 and the antenna array(s) 1016, may be configured to transmit RRC signaling, including a parameter indicating a subband full-duplex specification that is common to all signals and channels. According to some aspects, the subband full-duplex specification may be at least one of a timing advance parameter or a unified transmission configuration indicator state.

In some examples, the channels and signals configuration circuitry 1043, in conjunction with the transceiver 1014 and the antenna array(s) 1016, may be configured to at least one of: transmit a downlink bandwidth part configuration associated with the uplink subband-specific channels and signals configuration, or transmit an uplink bandwidth part configuration associated with the downlink subband-specific channels and signals configuration. According to some aspects, an association may be established by including an uplink subband full-duplex identifier (e.g., ul-subband-Id, ul-dl-subband-Id) within at least one of: the downlink bandwidth part configuration to associate the downlink bandwidth part configuration with the uplink SBFD-specific channels and signals configuration, or the uplink bandwidth part configuration, to associate the uplink bandwidth part configuration with the downlink SBFD-specific channels and signals configuration, respectively.

According to some aspects, the downlink subband-specific channels and signals configuration and the uplink subband-specific channels and signals configuration together may comprise a downlink-uplink subband-specific pair, and the processor 1004, or the channels and signals configuration circuitry 1043, in conjunction with the transceiver 1014 and the antenna array(s) 1016, may be further configured to: transmit a downlink bandwidth part configuration in association with the downlink-uplink subband-specific pair.

According to some aspects, the downlink subband-specific channels and signals configuration may be distinct from both a bandwidth part downlink common configuration and a bandwidth part downlink dedicated configuration, and the uplink subband-specific channels and signals configuration may be distinct from both a bandwidth part uplink common configuration and a bandwidth part uplink dedicated configuration.

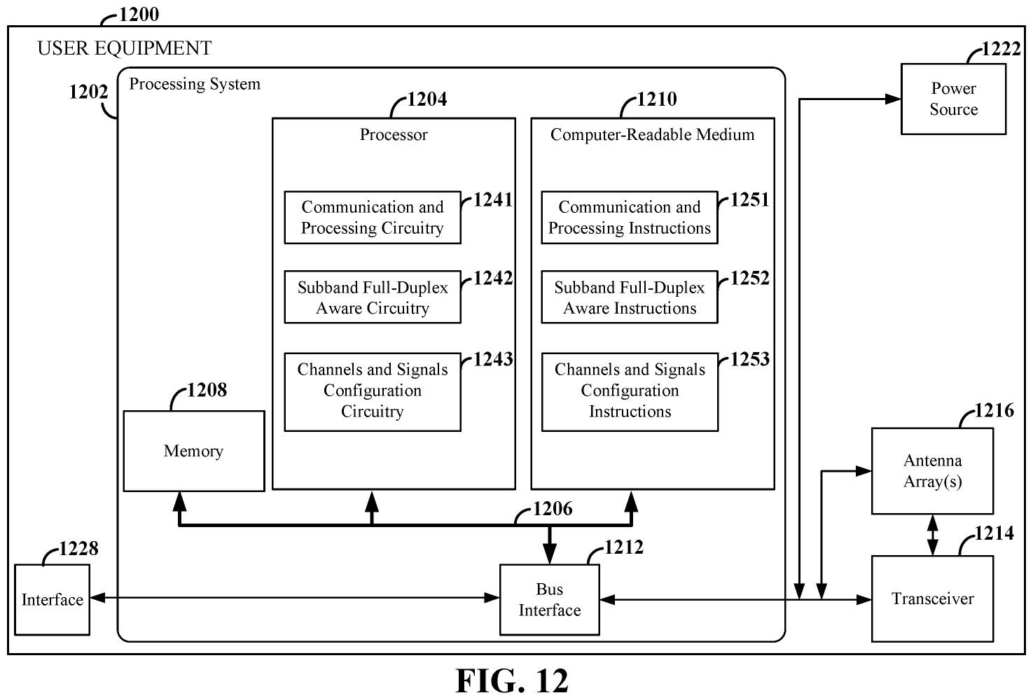

FIG. 12 is a block diagram illustrating an example of a hardware implementation of a user equipment 1200 (e.g., a wireless communication device, a mobile device, a scheduled entity) employing a processing system 1202 according to some aspects of the disclosure. For example, the user equipment 1200 may be similar to any one or more of the user equipment illustrated and described in FIGS. 1, 2, and/or 6.

In accordance with various aspects of the disclosure, an element, or any portion of an element, or any combination of elements may be implemented with a processing system 1202 that includes one or more processors 1204. The processing system 1202 may be substantially the same as the processing system 1002 illustrated and described in connection with FIG. 10, including a bus interface 1212, a bus 1206, memory 1208, a processor 1204, and a computer-readable medium 1210. Furthermore, the user equipment 1200 may include a user interface 1228, a transceiver 1214, an antenna array 1216, and a power source 1222, substantially similar to those described above in connection with FIG. 10. The processor 1204, as utilized in the user equipment 1200, may be used to implement any one or more of the processes described below.

The processor 1204 may include communication and processing circuitry 1241, configured to communicate with a network access node, similar to any network access node as shown and described in connection with FIGS. 1, 2, 6, and/or 10. In some examples, the communication and processing circuitry 1241 may include one or more hardware components that provide the physical structure that performs processes related to wireless communication (e.g., signal reception and/or signal transmission) and signal processing (e.g., processing a received signal and/or processing a signal for transmission). The communication and processing circuitry 1241 may further be configured to execute communication and processing instructions 1251 (e.g., software) stored on the computer-readable medium 1210 to implement one or more functions described herein. The communication and processing circuitry 1241 and the communication and processing instructions 1251 may be similar to the communication and processing circuitry 1041 and the communication and processing instructions 1051, respectively, as shown and described in connection with FIG. 10. Accordingly, a detailed description of the communication and processing circuitry 1241 and the communication and processing instructions 1251 is omitted for the sake of brevity.

In some aspects of the disclosure, the processor 1204 may include subband full-duplex aware circuitry 1242. The subband full-duplex aware circuitry 1242 may be configured for various functions, including, for example, transmitting an indication that the user equipment 1200 is aware of subband full-duplex operation in conjunction with communications between the user equipment 1200 and a network access node, such as the network access node in any one of FIGS. 1, 2, 6, and/or 10. The subband full-duplex aware circuitry 1242 may be configured to execute subband full-duplex aware instructions 1252 (e.g., software), stored, for example, on the computer-readable medium 1210, to implement one or more functions described herein.

In some aspects of the disclosure, the processor 1204 may include channels and signals configuration circuitry 1243. The channels and signals configuration circuitry 1243 may be configured for various functions, including, for example, receiving scheduling (and/or configuration) information from a network access node indicating that the UE is scheduled to transmit uplink or receive downlink in at least one of: a subband full-duplex (SBFD) slot, or a flexible symbol or slot. The received scheduling information, and/or configuration information, may be received via RRC signaling, for example. The receiving may be in response to transmitting an indication of subband full-duplex awareness from the UE. The scheduling (and/or configuration) information may include configuration parameters related to at least one of a downlink subband-specific channels and signals configuration or an uplink subband-specific channels and signals configuration. The scheduling (and/or configuration) information may be conveyed via, for example, radio resource control (RRC) signaling.

The channels and signals configuration circuitry 1243 may be configured for various other functions, including, for example, transmitting uplink traffic or uplink control data, or receiving downlink traffic or downlink control data, respectively, in an SBFD slot: according to subband-specific channels and signals configuration parameters configured to the UE in response to a duplexing mode of the UE including SBFD, and receiving downlink control information including a bit indicating the use of an SBFD mode, or according to bandwidth part configuration parameters configured to the UE in response to the UE being a time division duplex UE.

The channels and signals configuration circuitry 1243 may be configured for various other functions, including, for example, in response to a duplexing mode of the UE including SBFD, and receiving periodic or semi-persistent uplink or downlink channel or reference signal configurations, the processor 1204, or the channels and signals configuration circuitry 1243 of the processor 1204 may be further configured to: maintain the periodic or semi-persistent repetition of an uplink or a downlink channel or a reference signal associated with the uplink or a downlink channel or reference signal configuration in response to the uplink or the downlink channel or reference signal occurring in an SBFD slot; and drop the periodic or semi-persistent repetition of the uplink or the downlink channel or reference signal in response to the uplink or the downlink channel or reference signal occurring in a non-SBFD slot.

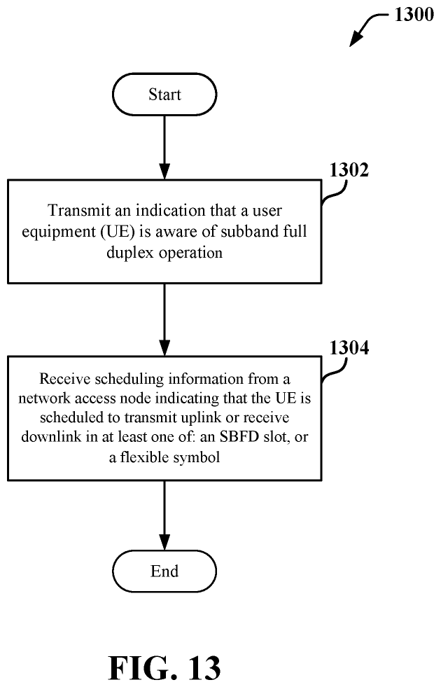

FIG. 13 is a flow chart illustrating an exemplary process 1300 (e.g., a method of wireless communication) at a user equipment (e.g., a wireless communication device, a mobile device, a scheduled entity) according to some aspects of the disclosure. The process 1300 may occur in a wireless communication network, such as the wireless communication networks of FIGS. 1, 2, and/or 6, for example. As described below, some or all illustrated features may be omitted in a particular implementation within the scope of the present disclosure, and some illustrated features may not be required for all implementations. In some examples, the process 1300 may be carried out by the user equipment 1200 as described and illustrated in connection with FIG. 12. In some examples, the process 1300 may be carried out by any suitable apparatus or means for carrying out the functions or algorithms described herein.

At block 1302, the user equipment, or the processor thereof, may transmit an indication that the user equipment is aware of subband full-duplex operation. For example, the subband full-duplex aware circuitry 1242, in conjunction with, for example, the transceiver 1214 and antenna array(s) 1216, all as shown and described in connection with FIG. 12, may provide a means for transmitting an indication that a user equipment is aware of subband full-duplex operation.

At block 1304, the user equipment, or the processor thereof, may receive scheduling information (e.g., in response to transmitting the indication at 1302) from a network access node indicating that the UE is scheduled to transmit uplink or receive downlink in at least one of: a subband full-duplex (SBFD) slot, or a flexible symbol or slot.

According to some aspects, the user equipment, or the processor thereof, may be further configured to: transmit uplink traffic or uplink control data, or receive downlink traffic or downlink control data, respectively, in the SBFD slot: according to subband-specific channels and signals configuration parameters configured to the UE in response to the UE being aware of SBFD, or according to bandwidth part configuration parameters configured to the UE in response to the UE being a time division duplex UE.

In some examples, in response to being aware of SBFD and receiving periodic or semi-persistent uplink or downlink channel or reference signal configurations, the UE, or the processor thereof, is further configured to: maintain the periodic or semi-persistent repetition of an uplink or a downlink channel or a reference signal associated with the uplink or a downlink channel or reference signal configuration in response to the uplink or the downlink channel or reference signal occurring in an SBFD slot; and drop the periodic or semi-persistent repetition of the uplink or the downlink channel or reference signal in response to the uplink or the downlink channel or reference signal occurring in a non-SBFD slot.

Deployment of communication systems, such as 5G new radio (NR) systems, may be arranged in multiple manners with various components or constituent parts. In a 5G NR system, or network, a network entity, a mobility element of a network, a radio access network (RAN) node, a core network entity, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, network access node, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

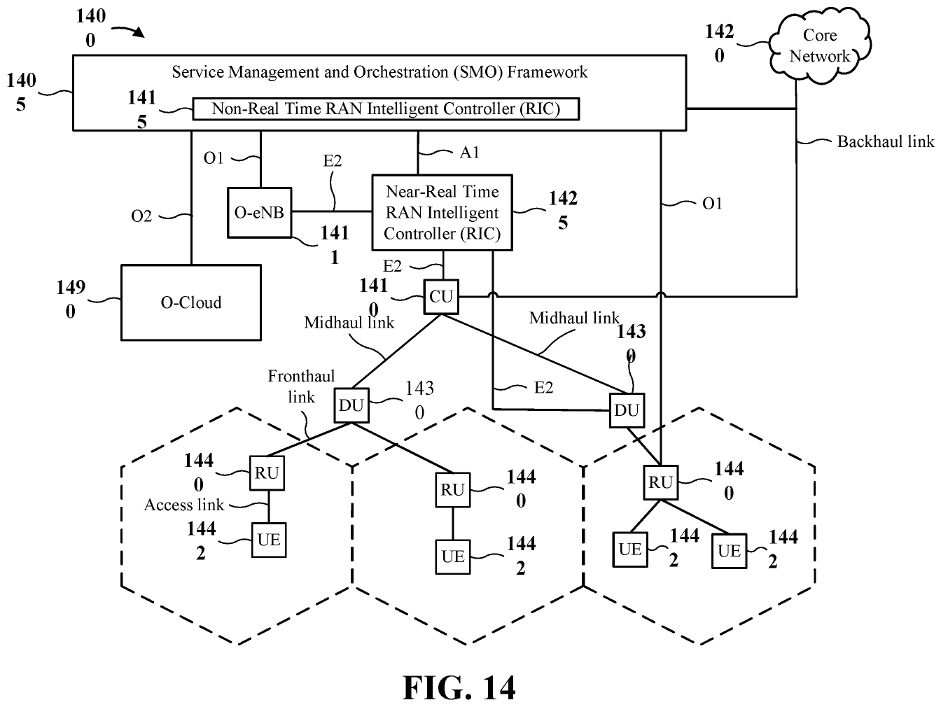

FIG. 14 is a schematic illustration of an example disaggregated base station 1400 architecture according to some aspects of the disclosure. The disaggregated base station 1400 architecture may include one or more central units (CUs) 1410 that can communicate directly with a core network 1420 via a backhaul link, or indirectly with the core network 1420 through one or more disaggregated base station units (such as a Near-Real Time (Near-RT) RAN Intelligent Controller (RIC) 1425 via an E2 link, or a Non-Real Time (Non-RT) RIC 1415 associated with a Service Management and Orchestration (SMO) Framework 1405, or both). A CU 1410 may communicate with one or more distributed units (DUs) 1430 via respective midhaul links, such as an F1 interface. The DUs 1430 may communicate with one or more radio units (RUs) 1440 via respective fronthaul links. The RUs 1440 may communicate with respective UEs 1442 via one or more radio frequency (RF) access links. In some implementations, the UE 1442 may be simultaneously served by multiple RUs 1440. UE 1442 may be the same or similar to any of the UEs or scheduled entities illustrated and described in connection with FIG. 1 and FIG. 2, for example.

Each of the units, i.e., the CUs 1410, the DUs 1430, the RUs 1440, as well as the Near-RT RICs 1425, the Non-RT RICs 1415, and the SMO Framework 1405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units. In some aspects, the CU 1410 may host one or more higher layer control functions.

Such control functions can include radio resource control (RRC), packet data convergence protocol (PDCP), service data adaptation protocol (SDAP), or the like. Each control function can be implemented with an interface configured to communicate signals with other control functions hosted by the CU 1410. The CU 1410 may be configured to handle user plane functionality (i.e., Central Unit-User Plane (CU-UP)), control plane functionality (i.e., Central Unit-Control Plane (CU-CP)), or a combination thereof. In some implementations, the CU 1410 can be logically split into one or more CU-UP units and one or more CU-CP units. The CU-UP unit can communicate bidirectionally with the CU-CP unit via an interface, such as the E1 interface when implemented in an O-RAN configuration. The CU 1410 can be implemented to communicate with the DU 1430, as necessary, for network control and signaling.

The DU 1430 may correspond to a logical unit that includes one or more base station functions to control the operation of one or more RUs 1440. In some aspects, the DU 1430 may host one or more of a radio link control (RLC) layer, a medium access control (MAC) layer, and one or more high physical (PHY) layers (such as modules for forward error correction (FEC) encoding and decoding, scrambling, modulation, and demodulation, or the like) depending, at least in part, on a functional split, such as those defined by the 14rd Generation Partnership Project (3GPP). In some aspects, the DU 1430 may further host one or more low PHY layers. Each layer (or module) can be implemented with an interface configured to communicate signals with other layers (and modules) hosted by the DU 1430, or with the control functions hosted by the CU 1410.

Lower-layer functionality can be implemented by one or more RUs 1440. In some deployments, an RU 1440, controlled by a DU 1430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 1440 can be implemented to handle over the air (OTA) communication with one or more UEs 1442. In some implementations, real-time and non-real-time aspects of control and user plane communication with the RU(s) 1440 can be controlled by the corresponding DU 1430. In some scenarios, this configuration can enable the DU(s) 1430 and the CU 1410 to be implemented in a cloud-based RAN architecture, such as a vRAN architecture.

The SMO Framework 1405 may be configured to support RAN deployment and provisioning of non-virtualized and virtualized network elements. For non-virtualized network elements, the SMO Framework 1405 may be configured to support the deployment of dedicated physical resources for RAN coverage requirements which may be managed via an operations and maintenance interface (such as an O1 interface). For virtualized network elements, the SMO Framework 1405 may be configured to interact with a cloud computing platform (such as an open cloud (O-Cloud) 1490) to perform network element life cycle management (such as to instantiate virtualized network elements) via a cloud computing platform interface (such as an O2 interface). Such virtualized network elements can include, but are not limited to, CUs 1410, DUs 1430, RUs 1440 and Near-RT RICs 1425. In some implementations, the SMO Framework 1405 can communicate with a hardware aspect of a 14G RAN, such as an open eNB (O-eNB) 1411, via an O1 interface. Additionally, in some implementations, the SMO Framework 1405 can communicate directly with one or more RUs 1440 via an O1 interface. The SMO Framework 1405 also may include a Non-RT RIC 1415 configured to support functionality of the SMO Framework 1405.

The Non-RT RIC 1415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1425. The Non-RT RIC 1415 may be coupled to or communicate with (such as via an AI interface) the Near-RT RIC 1425. The Near-RT RIC 1425 may be configured to include a logical function that enables near-real-time control and optimization of RAN elements and resources via data collection and actions over an interface (such as via an E2 interface) connecting one or more CUs 1410, one or more DUs 1430, or both, as well as an O-eNB, with the Near-RT RIC 1425.

In some implementations, to generate AI/ML models to be deployed in the Near-RT RIC 1425, the Non-RT RIC 1415 may receive parameters or external enrichment information from external servers. Such information may be utilized by the Near-RT RIC 1425 and may be received at the SMO Framework 1405 or the Non-RT RIC 1415 from non-network data sources or from network functions. In some examples, the Non-RT RIC 1415 or the Near-RT RIC 1425 may be configured to tune RAN behavior or performance. For example, the Non-RT RIC 1415 may monitor long-term trends and patterns for performance and employ AI/ML models to perform corrective actions through the SMO Framework 1405 (such as reconfiguration via 01) or via creation of RAN management policies (such as AI policies).

Of course, in the above examples, the circuitry included in the processor 1004 of FIG. 10 and/or the processor 1204 of FIG. 12 is merely provided as an example. Other means for carrying out the described processes or functions may be included within various aspects of the present disclosure, including but not limited to the instructions stored in the computer-readable medium 1010 of FIG. 10 and/or the computer-readable medium 1210 of FIG. 12, or any other suitable apparatus or means described in any one of the FIGS. 1, 2, 6, 10, 12, and/or 14 and utilizing, for example, the processes and/or algorithms described herein in relation to FIGS. 4, 5, 6, 7, 8, 9, 11, and/or 13.

The following provides an overview of aspects of the present disclosure:

Aspect 1: A network access node, comprising: a memory, and a processor coupled to the memory, wherein the processor is configured to, based at least in part on information stored in the memory: receive an indication that a user equipment is aware of subband full-duplex operation, and transmit, in response to receiving the indication, at least one of a downlink subband-specific channels and signals configuration or an uplink subband-specific channels and signals configuration utilizing radio resource control (RRC) signaling.

Aspect 2: The network access node of aspect 1, wherein the downlink subband-specific channels and signals configuration comprises at least one of: subband common parameters that are cell specific, subband dedicated parameters that are user equipment specific, or a combination of the subband common parameters and the subband dedicated parameters.

Aspect 3: The network access node of aspect 2, wherein the subband common parameters that are cell specific or the subband common parameters that are user equipment specific are configured per cell or per bandwidth part (BWP), respectively.

Aspect 4: The network access node of any of aspects 1 through 3, wherein multiple subband configurations are configured and each subband configuration is labeled with an identifier (ID).

Aspect 5: The network access node of any of aspects 1 through 4, wherein the RRC signaling associated with the downlink subband-specific channels and signals configuration comprises: at least one of: physical downlink shared channel configuration parameters, physical downlink control channel configuration parameters, a semi-persistent scheduling configuration parameter, or a downlink subband timing and frequency indication parameter; and the RRC signaling associated with the uplink subband-specific channels and signals configuration comprises: at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter.

Aspect 6: The network access node of any of aspects 1 through 5, wherein the RRC signaling includes a parameter indicating that the downlink subband-specific channels and signals configuration or the uplink subband-specific channels and signals configuration is dedicated to a specific channel or a specific signal.

Aspect 7: The network access node of any of aspects 1 through 6, wherein the processor is further configured to: transmit RRC signaling including a parameter indicating a subband full-duplex specification that is common to all signals and channels.

Aspect 8: The network access node of aspect 7, wherein the subband full-duplex specification is at least one of a timing advance parameter or a unified transmission configuration indicator state.

Aspect 9: The network access node of any of aspects 1 through 8, wherein the processor is further configured to at least one of: transmit a downlink bandwidth part configuration associated with the uplink subband-specific channels and signals configuration, or transmit an uplink bandwidth part configuration associated with the downlink subband-specific channels and signals configuration.

Aspect 10: The network access node of aspect 9, wherein an association is established by including an uplink subband identifier (e.g., ul-subband-Id, ul-dl-subband-id) within the at least one of: the downlink bandwidth part configuration, to associate the downlink bandwidth part configuration with the uplink subband-specific channels and signals configuration, or the uplink bandwidth part configuration, to associate the uplink bandwidth part configuration with the downlink subband-specific channels and signals configuration, respectively.

Aspect 11: The network access node of any of aspects 1 through 10, wherein the downlink subband-specific channels and signals configuration and the uplink subband-specific channels and signals configuration together comprise a downlink-uplink subband-specific pair, and the processor is further configured to: transmit a downlink bandwidth part configuration in association with the downlink-uplink subband-specific pair.

Aspect 12: The network access node of any of aspects 1 through 11, wherein the downlink subband-specific channels and signals configuration is distinct from both a bandwidth part downlink common configuration and a bandwidth part downlink dedicated configuration, and the uplink subband-specific channels and signals configuration is distinct from both a bandwidth part uplink common configuration and a bandwidth part uplink dedicated configuration.

Aspect 13. A method, operational at a network access node, the method comprising: receiving an indication that a user equipment is aware of subband full-duplex operation, and transmitting, in response to receiving the indication, at least one of a downlink subband-specific channels and signals configuration or an uplink subband-specific channels and signals configuration utilizing radio resource control (RRC) signaling.

Aspect 14: An apparatus, comprising: means for receiving an indication that a user equipment is aware of subband full-duplex operation, and means for transmitting, in response to receiving the indication, at least one of a downlink subband-specific channels and signals configuration or an uplink subband-specific channels and signals configuration utilizing radio resource control (RRC) signaling.

Aspect 15: A computer-readable medium storing computer-executable code comprising instructions for: receiving an indication that a user equipment is aware of subband full-duplex operation, and transmitting, in response to receiving the indication, at least one of a downlink subband-specific channels and signals configuration or an uplink subband-specific channels and signals configuration utilizing radio resource control (RRC) signaling.

Aspect 16: A user equipment (UE), comprising: a memory, and a processor coupled to the memory, wherein the processor is configured to, based at least at least in part on information stored in the memory: receive scheduling information from a network access node indicating that the UE is scheduled to transmit uplink or receive downlink in at least one of: a subband full-duplex (SBFD) slot, or a flexible symbol or slot.

Aspect 17: The user equipment of aspect 16, wherein the processor is further configured to: transmit uplink traffic or uplink control data, or receive downlink traffic or downlink control data, respectively, in the SBFD slot: according to subband-specific channels and signals configuration parameters configured to the UE in response to the UE being aware of SBFD, or according to bandwidth part configuration parameters configured to the UE in response to the UE being a time division duplex UE.

Aspect 18: The user equipment of aspect 16 or 17, wherein the processor is further configured to: transmit uplink traffic or uplink control data, or receive downlink traffic or downlink control data, respectively in the flexible symbol or slot: according to subband-specific channels and signals configuration parameters configured to the UE in response to a duplexing mode of the UE including SBFD, and receiving downlink control information including a bit indicating a use of an SBFD mode, or according to bandwidth part configuration parameters configured to the UE in response to the UE being a time division duplex UE.

Aspect 19: The user equipment of any of aspects 16 through 18, wherein in response to the UE being aware of SBFD and receiving periodic or semi-persistent uplink or downlink channel or reference signal configurations, the processor is further configured to: maintain the periodic or semi-persistent repetition of an uplink or a downlink channel or a reference signal associated with the uplink or a downlink channel or reference signal configuration in response to the uplink or the downlink channel or reference signal occurring in an SBFD slot, and drop the periodic or semi-persistent repetition of the uplink or the downlink channel or reference signal in response to the uplink or the downlink channel or reference signal occurring in a non-SBFD slot.

Aspect 20. A method, operational at a user equipment, the method comprising: receiving scheduling information from a subband full-duplex-capable network access node indicating that the UE is scheduled to transmit uplink or receive downlink in at least one of: a subband full-duplex (SBFD) slot, or a flexible symbol or slot.

Aspect 21: An apparatus, comprising: means for receiving scheduling information from a subband full-duplex-capable network access node indicating that the UE is scheduled to transmit uplink or receive downlink in at least one of: a subband full-duplex (SBFD) slot, or a flexible symbol or slot.

Aspect 22: A computer-readable medium storing computer-executable code comprising instructions for: receiving scheduling information from a subband full-duplex-capable network access node indicating that the UE is scheduled to transmit uplink or receive downlink in at least one of: a subband full-duplex (SBFD) slot, or a flexible symbol or slot.

Aspect 23: A method of wireless communication at a network access node within a wireless network for implementing any feature described in the attached specification, either individually or in combination with any other feature, in any configuration.

Aspect 24: A network access node configured for wireless communication, comprising: a processor, a memory communicatively coupled to the processor, and a transceiver communicatively coupled to the processor, wherein the processor is configured to, based at least in part on information stored in the memory, implement any feature described in the attached specification, either individually or in combination with any other feature, in any configuration.

Aspect 25: A network access node for wireless communication, comprising: means for implementing any feature described in the attached specification, either individually or in combination with any other feature, in any configuration.

Aspect 26: A computer-readable medium storing computer-executable code comprising instructions for implementing any feature described in the attached specification, either individually or in combination with any other feature, in any configuration.

Aspect 27: A method of wireless communication at a wireless communication device within a wireless network for implementing any feature described in the attached specification, either individually or in combination with any other feature, in any configuration.

Aspect 28: A wireless communication device configured for wireless communication, comprising: a processor, a memory communicatively coupled to the processor, and a transceiver communicatively coupled to the processor, wherein the processor is configured to, based at least in part on information stored in the memory, implement any feature described in the attached specification, either individually or in combination with any other feature, in any configuration.

Aspect 29: A wireless communication device for wireless communication, comprising: means for implementing any feature described in the attached specification, either individually or in combination with any other feature, in any configuration.

Aspect 30: A computer-readable medium storing computer-executable code comprising instructions for implementing any feature described in the attached specification, either individually or in combination with any other feature, in any configuration.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A network access node, comprising:
a memory; and
a processor coupled to the memory, wherein the processor is configured to, based at least in part on information stored in the memory:
receive an indication that a user equipment is aware of subband full-duplex operation; and
transmit, in response to receiving the indication, at least one of a downlink subband-specific channels and signals configuration or an uplink subband-specific channels and signals configuration utilizing radio resource control (RRC) signaling.

2. The network access node of claim 1, wherein the downlink subband-specific channels and signals configuration comprises at least one of:
subband common parameters that are cell specific,
subband dedicated parameters that are user equipment specific, or
a combination of the subband common parameters and the subband dedicated parameters.

3. The network access node of claim 2, wherein the subband common parameters that are cell specific or the subband dedicated parameters that are user equipment specific are configured per cell or per bandwidth part (BWP), respectively.

4. The network access node of claim 2, wherein multiple subband configurations are configured and each subband configuration is labeled with an identifier (ID).

5. The network access node of claim 1, wherein the processor is further configured to, based at least in part on information stored in the memory:
transmit at least one of: physical downlink shared channel configuration parameters, physical downlink control channel configuration parameters, a semi-persistent scheduling configuration parameter, or a downlink subband timing and frequency indication parameter with the RRC signaling associated with the downlink subband-specific channels and signals configuration; and
transmit at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter with the RRC signaling associated with the uplink subband-specific channels and signals configuration.

6. The network access node of claim 1, wherein the processor is further configured to:
transmit a parameter indicating that the downlink subband-specific channels and signals configuration or the uplink subband-specific channels and signals configuration is dedicated to a specific channel or a specific signal with the RRC signaling.

7. The network access node of claim 1, wherein the processor is further configured to:
transmit the RRC signaling including a parameter indicating a subband full-duplex specification that is common to all signals and channels.

8. The network access node of claim 7, wherein the subband full-duplex specification is at least one of a timing advance parameter or a unified transmission configuration indicator state.

9. The network access node of claim 1, wherein the processor is further configured to, based at least in part on information stored in the memory, at least one of:
transmit a downlink bandwidth part configuration associated with the uplink subband-specific channels and signals configuration, or
transmit an uplink bandwidth part configuration associated with the downlink subband-specific channels and signals configuration.

10. The network access node of claim 9, wherein the processor is further configured to:
transmit a subband identifier within the at least one of:
the downlink bandwidth part configuration to associate the downlink bandwidth part configuration with the uplink subband-specific channels and signals configuration, or
the uplink bandwidth part configuration, to associate the uplink bandwidth part configuration with the downlink subband-specific channels and signals configuration, respectively.

11. The network access node of claim 1, wherein the downlink subband-specific channels and signals configuration and the uplink subband-specific channels and signals configuration together comprise a downlink-uplink subband-specific pair, and the processor is further configured to:
transmit a downlink bandwidth part configuration in association with the downlink-uplink subband-specific pair.

12. The network access node of claim 1, wherein
the downlink subband-specific channels and signals configuration is distinct from both a bandwidth part downlink common configuration and a bandwidth part downlink dedicated configuration, and
the uplink subband-specific channels and signals configuration is distinct from both a bandwidth part uplink common configuration and a bandwidth part uplink dedicated configuration.

13. A method, operational at a network access node, the method comprising:
receiving an indication that a user equipment is aware of subband full-duplex operation; and
transmitting, in response to receiving the indication, at least one of a downlink subband-specific channels and signals configuration or an uplink subband-specific channels and signals configuration utilizing radio resource control (RRC) signaling.

14. The method of claim 13, wherein the downlink subband-specific channels and signals configuration comprises at least one of:
subband common parameters that are cell specific,
subband dedicated parameters that are user equipment specific, or
a combination of the subband common parameters and the subband dedicated parameters.

15. The method of claim 14, wherein the subband common parameters that are cell specific or the subband dedicated parameters that are user equipment specific are configured per cell or per bandwidth part (BWP), respectively.

16. The method of claim 14, wherein multiple subband configurations are configured and each subband configuration is labeled with an identifier (ID).

17. The method of claim 13, further comprising:
transmitting at least one of: physical downlink shared channel configuration parameters, physical downlink control channel configuration parameters, a semi-persistent scheduling configuration parameter, or a downlink subband timing and frequency indication parameter with the RRC signaling associated with the downlink subband-specific channels and signals configuration; and
transmitting at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter with the RRC signaling associated with the uplink subband-specific channels and signals configuration.

18. The method of claim 13, further comprising:
transmitting a parameter indicating that the downlink subband-specific channels and signals configuration or the uplink subband-specific channels and signals configuration is dedicated to a specific channel or a specific signal with the RRC signaling.

19. The method of claim 13, further comprising:
transmitting the RRC signaling including a parameter indicating a subband full-duplex specification that is common to all signals and channels.

20. The method of claim 19, wherein the subband full-duplex specification is at least one of a timing advance parameter or a unified transmission configuration indicator state.

21. The method of claim 13, further comprising at least one of:
transmitting a downlink bandwidth part configuration associated with the uplink subband-specific channels and signals configuration, or
transmitting an uplink bandwidth part configuration associated with the downlink subband-specific channels and signals configuration.

22. The method of claim 21, further comprising:
transmitting a subband identifier within the at least one of:
the downlink bandwidth part configuration to associate the downlink bandwidth part configuration with the uplink subband-specific channels and signals configuration, or
the uplink bandwidth part configuration, to associate the uplink bandwidth part configuration with the downlink subband-specific channels and signals configuration, respectively.

23. The method of claim 13, wherein the downlink subband-specific channels and signals configuration and the uplink subband-specific channels and signals configuration together comprise a downlink-uplink subband-specific pair, the method further comprising:
transmitting a downlink bandwidth part configuration in association with the downlink-uplink subband-specific pair.

24. The method of claim 13, wherein
the downlink subband-specific channels and signals configuration is distinct from both a bandwidth part downlink common configuration and a bandwidth part downlink dedicated configuration, and
the uplink subband-specific channels and signals configuration is distinct from both a bandwidth part uplink common configuration and a bandwidth part uplink dedicated configuration.

25. An apparatus, comprising:
means for receiving an indication that a user equipment is aware of subband full-duplex operation; and
means for transmitting, in response to receiving the indication, at least one of a downlink subband-specific channels and signals configuration or an uplink subband-specific channels and signals configuration utilizing radio resource control (RRC) signaling.

26. The apparatus of claim 25, further comprising:
means for transmitting at least one of: physical downlink shared channel configuration parameters, physical downlink control channel configuration parameters, a semi-persistent scheduling configuration parameter, or a downlink subband timing and frequency indication parameter with the RRC signaling associated with the downlink subband-specific channels and signals configuration; and
means for transmitting at least one of: physical uplink shared channel configuration parameters, physical uplink control channel configuration parameters, uplink configured grant configuration parameters, sounding reference signal configuration parameters, physical random access channel (PRACH) configuration parameters, or an uplink subband timing and frequency indication parameter with the RRC signaling associated with the uplink subband-specific channels and signals configuration.

27. The apparatus of claim 25, further comprising:
transmitting a parameter indicating that the downlink subband-specific channels and signals configuration or the uplink subband-specific channels and signals configuration is dedicated to a specific channel or a specific signal with the RRC signaling.

28. The apparatus of claim 25, further comprising at least one of:
means for transmitting a downlink bandwidth part configuration associated with the uplink subband-specific channels and signals configuration, or
means for transmitting an uplink bandwidth part configuration associated with the downlink subband-specific channels and signals configuration.

29. The apparatus of claim 28, further comprising:
means for transmitting a subband identifier within the at least one of:
the downlink bandwidth part configuration to associate the downlink bandwidth part configuration with the uplink subband-specific channels and signals configuration, or
the uplink bandwidth part configuration, to associate the uplink bandwidth part configuration with the downlink subband-specific channels and signals configuration, respectively.

30. The apparatus of claim 25, wherein the downlink subband-specific channels and signals configuration and the uplink subband-specific channels and signals configuration together comprise a downlink-uplink subband-specific pair, the apparatus further comprising:
means for transmitting a downlink bandwidth part configuration in association with the downlink-uplink subband-specific pair.
